(19) United States
(12) Patent Application Publication
(10) Pub. No.: US 2025/0326914 A1
(43) Pub. Date: Oct. 23, 2025

(54) ETHYLENE/ALPHA-OLEFIN INTERPOLYMER COMPOSITIONS FOR EXTRUSION APPLICATIONS

(71) Applicant: Dow Global Technologies LLC, Midland, MI (US)

(72) Inventors: Yunfeng Yang, Shanghai (CN); Colin Li Pi Shan, Pearland, TX (US); Gaoxiang Wu, Houston, TX (US); Yabin Sun, Shanghai (CN)

(21) Appl. No.: 18/866,651

(22) PCT Filed: Aug. 12, 2022
(86) PCT No.: PCT/CN2022/112056

§ 371 Date: Nov. 18, 2024

(51) Int. Cl. C08K 5/3432; C08F 4/64; C08F 210/16; C08J 3/24; C08K 3/04; C08K 5/14

(52) U.S. Cl. CPC C08K 5/3432; C08F 4/64193; C08F 210/16; C08J 3/24; C08K 3/04; C08K 5/14; C08J 2323/08

(57) ABSTRACT

Compositions and related processes comprising the following components a) and b): a) a first composition comprising a multimodal ethylene/alpha-olefin interpolymer, and wherein the first composition comprises the following properties: i) a density from 0.855 to 0.900 g/cc, ii) a [V100 (190° C.)]≤1000 Pa·s, iii) a [V0.1 (190° C.)/V100 (190° C.)]≥8.0, b) at least one peroxide. Compositions and related processes comprising the following components a) through c): a) an first composition comprising a multimodal ethylene/alpha-olefin interpolymer, and wherein the first composition comprises the following properties: i) a density from 0.855 to 0.900 g/cc, ii) a [V0.1 (190° C.)/V100 (190° C.)]≥5.0, b) at least one peroxide, c) at least one Tempo compound of Structure I) selected from Structure IA, Structure IB or Structure IC, each as described herein.

### BACKGROUND OF THE INVENTION

Vulcanized EPDM is the incumbent of weatherstrip profile material, which is highly filled with carbon black and a plasticizer oil, and is cured by a complex sulfur curative system. Nowadays, the automotive industry is seeking to make lightweight vehicles (especially lightweight electric cars), which are less conductive and have lower VOC values, and thus, lower odor. Typical vulcanized EPDM cannot meet all of these needs well.

Extrusion and continuous vulcanization (CV) are the most common processing methods to make the weatherstrip profile. To make a “high polymer content” profile, conventional EPDM is not suitable, since a high amount of carbon black and oil are needed to reduce the intrinsically high viscosity of the EPDM. The filler adds to the weight of the profile.

When a conventional polyolefin elastomer (POE) composition containing a high polymer content (for example, ≥90 wt %, based on the weight of the composition) is used to extrude a profile, which is then crosslinked under a high temperature CV, there is usually a tradeoff between the surface quality of the extrudate and the shape retention of the extrudate. When the “POE composition” has a high flowability, a good quality surface can be obtained via extrusion, but the profile shape cannot be maintained during the CV process. Compositions containing high molecular weight (high viscosity) POE can help maintain the extrudate shape, but the extrudate surface become non-uniform and rough (i.e., a poor quality surface).

There is a need for new polymer compositions that can be extruded with a good surface quality and also maintain the extrudate shape during the curing in a CV tunnel. Such compositions should contain no, or low amounts of, filler.

International Publication WO2021/128128 discloses a composition comprising the following components a)-c): a) an alpha composition comprising a multimodal ethylene/alpha-olefin interpolymer, and wherein the alpha composition comprises the following properties: i) an Mz/Mn≥8.0, ii) a density from 0.855 to 0.890 g/cc, iii) a V100 (100° C.)≤2,000 Pa·s, iv) a V1.0 (100° C.)≥15,000 Pa·s, v) a Mn≥16,000 g/mol; b) a peroxide; and c) a silane coupling agent.

U.S. Pat. No. 9,102,824 discloses a composition comprising a first composition, which comprises the following: A) a first interpolymer comprising, in polymerized form, ethylene, an α-olefin and a nonconjugated polyene; B) a second interpolymer comprising, in polymerized form, ethylene, an α-olefin and a nonconjugated polyene; and wherein the first composition has an [(ML(1+4, 125° C.))/Mw(conv)]*1000 greater than 0.429 mole/g, and wherein the ratio of the Mooney (ML, 1+4, 125° C.) of the first interpolymer to the second interpolymer is from 1.1 to 1.2; and wherein the first interpolymer has a Mooney viscosity (ML, 1+4, 125° C.) less than, or equal to, 120. See claim 1. Vulcanizing agents include, but are not limited to, sulfur-containing compounds and peroxides (see, for example, column 10, lines 33-60).

U.S. Publication 2019/0276573 discloses a multimodal elastomer comprising a copolymer of ethylene and at least one alpha-olefin monomer, wherein the multimodal elastomer comprises the following: 20 to 90% by weight of a high molecular weight (HMW) fraction, wherein the HMW fraction has a number average molecular weight (Mn) of at least 50 kg/mol, and comprises at least 35% by weight ethylene and at least 30% by weight alpha-olefin comonomer; and a low molecular weight fraction (LMW) fraction, wherein the LMW fraction has an Mn of 4 to 25 kg/mol, and comprises at least 50% by weight ethylene and at least 29% by weight alpha-olefin comonomer. The ratio of the Mn of HMW fraction to the Mn of the LMW fraction is at least 5 to 1. The multimodal elastomer has a density between 0.853 to 0.875 g/cc, a shear viscosity at 100 rad/s of less than 2,500 Pa·s, and a shear viscosity at 0.1 rad/s of less than 120 000 Pa·s. See claim 1.

U.S. Pat. No. 6,541,592 discloses a thermoplastic elastomer composition comprising the following: 5 to 95 wt % of (A) and 5 to 95 wt % of (B): (A) an ethylene-alpha-olefin polymer having a tensile stress M₁₀₀ of 2.5 MPa or less; (B) a polyolefin-based resin having a tensile stress M₁₀₀ of 2.5 MPa or more. The flowability index I, according to a test for flow properties with a capillary rheometer, is 1.35 or more. See Abstract. The composition may be crosslinked using sulfur, peroxide, a metal ion, silane, water or other conventional method (see column 9, lines 53-57).

U.S. Publication 2020/0263018 discloses a composition comprising the following: A) an ethylene/alpha-olefin/diene interpolymer; B) a peroxide comprising at least one peroxide bond; and C) a bis-TEMPO compound having the Structure (I) as described therein. The ratio of the molar amount of nitroxide groups of component C to the molar amount of the peroxide bonds of component B is from 0.100:1.000 to 2.000:1.000. See abstract.

International Publication WO2020/140067 discloses a curable composition comprising the following: A) a polyolefin component and B) a curing component comprising a cross-linking agent. The polyolefin component comprises an unsaturated polyolefin of the formula A¹L¹, and where L¹ is a polyolefin, and A¹ is selected from the group consisting of a vinyl group, a vinylidene group of the formula CH₂═C(Y¹)—, a vinylene group of the formula Y¹CH═CH—, a mixture of a vinyl group and a vinylene group of the formula Y¹CH═CH—, a mixture of a vinyl group and a vinylidene group of the formula CH₂═C(Y¹)—, a mixture of a vinylidene group of the formula CH₂═C(Y¹)— and a vinylene group of the formula Y¹CH═CH—, and a mixture of a vinyl group, a vinylidene group of the formula CH₂═C(Y¹)—, and a vinylene group of the formula Y¹CH═CH—; and Y¹ at each occurrence independently is a C1 to C30 hydrocarbyl group. See claim 1. The curing component may also contain a scorch inhibitor/retardant, such as a hindered phenol, a semi hindered phenol; TEMPO; a TEMPO derivative; 1,1-diphenylethylene; 2,4-diphenyl-4-methyl-1-pentene; and allyl-containing compounds described in U.S. Pat. No. 6,277,925B1. See paragraph [0247]. See also WO2020/140061, WO2020/135681, WO2020/135708, WO2020/135680, WO2020/139993 and WO2020/140058.

U.S. Pat. No. 8,581,094, discloses an electronic device module comprising the following: A) At least one electronic device, and B) a polymeric material in intimate contact with at least one surface of the electronic device. The polymeric material comprises components (1) and optionally (2) and (3) as follows: (1) a polyolefin copolymer with at least one of (a) a density of less than about 0.90 g/cc, (b) a 2% secant modulus of less than about 150 mega Pascal (mPa), (c) a melt point of less than about 95° C., (d) an alpha-olefin content of at least about 15 and less than about 50 wt %, based on the weight of the polymer, (e) a Tg of less than about −35° C., and (f) a SCBDI of at least about 50; (2) optionally, a free radical initiator (e.g., a peroxide or azo compound) or a photoinitiator (e.g., benzophenone); and (3) optionally, a co-agent. See abstract. Typically, the polyolefin copolymer is an ethylene/alpha-olefin copolymer. Optionally, the polymeric material can further comprise a vinyl silane and/or a scorch inhibitor, and the copolymer can be uncrosslinked or crosslinked. See abstract. Scorch inhibitors include 4-hydroxy-2,2,6,6-tetramethylpiperidin-1-oxyl also known as nitroxyl 2, or NR 1, or 4-oxypiperidol, or tanol, or tempol, or tmpn, or 4-hydroxy-TEMPO (see column 11, lines 30-54).

J. Kruzelak, et al., Vulcanization of Rubber Compounds with Peroxide Curing Systems, Rubber Chemistry and Technology, 90(1), 60-88, 2017; discloses the characterization of organic peroxides as curing agents and their decomposition mechanisms. This reference also discloses the classification and characterization of co-agents used in peroxide cross-linking, and the mutual interactions and reaction mechanisms between peroxide, co-agents, and rubber matrices, in relation to the properties of prepared materials. See abstract. This reference discloses scorch retardants such as 2,6-di-tert-butyl-4-methylphenol (BHT); 2,4-diphenyl-4-methyl-1-pentene(methyl styrene dimer, MSD); 1,1-diphenylethylene (DPE); (2,2,6,6-tetramethyl-piperidin-1-yl)oxyl (TEMPO); bis-(2,2,6,6-tetramethyl-4-piperidinyl) sebacate (bis-TEMPO); or acrylate-functionalized TEMPO; 4-acryloyloxy-2,2,6,6-tetramethyl-piperidine-N-oxyl (AOTEMPO). See page 83.

Additional polymer compositions are disclosed in the following references: EP2958151A1, EP2637217A1, EP2747150A1, WO 2011/033232, US2012/0273718.

However, as discussed above, there remains a need for new polymer compositions that can be extruded with a good surface quality and also maintain the extrudate shape during the curing in a CV tunnel. Such compositions should contain no, or low amounts of, filler. These needs have been met by the following invention.

### SUMMARY OF THE INVENTION

In a first aspect, a composition comprising the following components a) and b):
a) a first composition comprising a multimodal ethylene/alpha-olefin interpolymer, and wherein the first composition comprises the following properties:

$$i ) a density from 0.855 to 0.9 g / cc ,$$

$$ii ) a [ V 100 ( 190 ° C . ) ] \leq 1000 Pa \cdot s ,$$

$$iii ) a [ V 0.1 ( 190 ° C . ) / V 100 ( 190 ° C . ) ] \geq 8. ,$$

b) at least one peroxide.

In a second aspect, a composition comprising the following components a)-c):
a) an first composition comprising a multimodal ethylene/alpha-olefin interpolymer, and wherein the first composition comprises the following properties:

$$i ) a density from 0.855 to 0.9 g / cc ,$$

$$ii ) a [ V 0.1 ( 190 ° C . ) / V 100 ( 190 ° C . ) ] \geq 5. ,$$

b) at least one peroxide,
c) at least one Tempo compound of Structure I) selected from Structure IA, Structure IB or Structure IC, each as described herein.

In a third aspect, a process to form a crosslinked composition, the process comprising thermally treating a composition comprising the following components a) and b):
a) a first composition comprising a multimodal ethylene/alpha-olefin interpolymer, and wherein the first composition comprises the following properties:

$$i ) a density from 0.855 to 0.9 g / cc ,$$

$$ii ) a [ V 100 ( 190 ° C . ) ] \leq 1000 Pa \cdot s ,$$

$$iii ) a [ V 0.1 ( 190 ° C . ) / V 100 ( 190 ° C . ) ] \geq 8. ,$$

b) at least one peroxide.

In a fourth aspect, a process to form a crosslinked composition, the process comprising thermally treating a composition comprising the following components a)-c):
a) an first composition comprising a multimodal ethylene/alpha-olefin interpolymer, and wherein the first composition comprises the following properties:

$$i ) a density from 0.855 to 0.9 g / cc ,$$

$$ii ) a [ V 0.1 ( 190 ° C . ) / V 100 ( 190 ° C . ) ] \geq 5. ,$$

b) at least one peroxide,
c) at least one Tempo compound of Structure I) selected from Structure IA, Structure IB or Structure IC, each as described herein.

### DETAILED DESCRIPTION OF THE INVENTION

Compositions have been discovered that contain high levels of polymer (for example, ≥90 wt %, based on the weight of the composition) and that can be extruded with a good surface quality and can also maintain the extrudate shape during the curing in a CV tunnel.

As discussed above, in a first aspect, a composition comprising the following components a) and b), each as described herein. In a second aspect, a composition comprising the following components a) through c), each as described herein. In a third aspect, process to form a crosslinked composition, the process comprising thermally treating a composition comprising the following components a) and b), each as described herein. In a fourth aspect, a process to form a crosslinked composition, the process comprising thermally treating a composition comprising the following components a) through c), each as described herein. Each composition may comprise a combination of two or more embodiments, as described herein. Each process may comprise a combination of two or more embodiments, as described herein. Each component a, b and c may comprise a combination of two or more embodiments, as described herein. The following embodiments apply to the first, second, third and fourth aspects unless otherwise noted.

Note, as used herein, in reference to Structure IA, Structure IB or Structure IC (see component c), R1=R¹, R2=R², R3=R³, etc. Also, in regard to the number of carbon atoms in a chemical substituent of Structure IA, Structure IB or Structure IC, the notation, for example, “C1-C18,” where “1 through 18” represents consecutive numbers from 1 to 18, refers to “from 1 to 18 carbon atoms” that may be present in the substituent. An “alkyl” group may be linear, branched, cyclic, or any combination thereof. An “alkylene” group may be linear, branched, cyclic, or any combination thereof.

In regard to the first and third aspects, in one embodiment, or a combination of two or more embodiments, each described herein, the first composition has a V0.1 (190° C., Pa·s)≥3,000, or ≥3,200, or ≥3,400, or ≥3,600, or ≥4,000, or ≥4,500, or ≥5,000, and/or 30,000, or ≤25,000, or ≤20,000, or ≤18,000.

In regard to the second and fourth aspects, in one embodiment, or a combination of two or more embodiments, each described herein, the first composition has a melt index (I2, g/10 min)≤5.0, or ≤4.8, or ≤4.6 and/or ≥0.1, or ≥0.2, or ≥0.4, or ≥0.6, or ≥0.8, or ≥1.0.

In regard to the first and third aspects, in one embodiment, or a combination of two or more embodiments, each described herein, the composition further comprises as component c, at least one Tempo compound of Structure I as described herein.

In one embodiment, or a combination of two or more embodiments, each described herein, the molar ratio of the NO⁻ from the at least one Tempo compound (component c) to the peroxide (O—O) bonds from the at least one peroxide (component b) is from ≥0.30, or ≥0.31, or ≥0.33, or ≥0.34 and/or ≤0.90, or ≤0.88, or ≤0.85, or ≤0.82, or ≤0.80, or ≤0.78, or ≤0.75, or ≤0.72, or ≤0.70, or ≤0.68, or ≤0.65, or ≤0.62, or ≤0.60, or ≤0.58.

In one embodiment, or a combination of two or more embodiments, each described herein, component c is present in an amount from ≥0.20, or ≥0.22, or ≥0.25, or ≥0.28, or ≥0.30, or ≥0.32, or ≥0.35, or ≥0.38, or ≥0.40, or ≥0.42 or ≥0.45 phr and/or ≤0.90, or ≤0.88, or ≤0.85, or ≤0.82, or ≤0.80, or ≤0.78, or ≤0.75 phr, based on 100 parts of component a.

In one embodiment, or a combination of two or more embodiments, each described herein, the first composition has a total unsaturation≥0.20/1000C, or ≥0.25/1000C, or ≥0.30/1000C, or ≥0.35/1000C, or ≥0.40/1000C, or ≥0.45/1000C, or ≥0.50/1000C, or ≥0.51/1000C, or ≥0.52/1000C, or ≥0.53/1000C and/or ≤15.0/1000C, or ≤10.0/1000C, or ≤5.00/1000C, or ≤2.00/1000C, ≤1.50/1000C, ≤1.20/1000C, or ≤1.00/1000C.

In one embodiment, or a combination of two or more embodiments, each described herein, the multimodal ethylene/alpha-olefin interpolymer is selected from a multimodal ethylene/alpha-olefin copolymer.

In one embodiment, or a combination of two or more embodiments, each described herein, component a further comprises second multimodal ethylene/alpha-olefin interpolymer with a density from 0.855 to 0.900 g/cc, and a total unsaturation≥0.20/1000C, and this second interpolymer is different from the multimodal ethylene/alpha-olefin interpolymer, and further different in one or more features selected from density, total unsaturation, melt index (I2), or any combination therein.

In one embodiment, or a combination of two or more embodiments, each described herein, the second multimodal ethylene/alpha-olefin interpolymer is a multimodal ethylene/alpha-olefin copolymer.

In one embodiment, or a combination of two or more embodiments, each described herein, the ratio of the density of the multimodal ethylene/alpha-olefin interpolymer to the density of the second multimodal ethylene/alpha-olefin interpolymer is 0.80, or ≥0.85, or ≥0.90, or ≥0.92, or ≥0.94, or ≥0.96, or ≥0.98 or ≥1.0, and/or 1.25, or ≤1.20, or ≤1.18, or ≤1.16, or ≤1.14, or ≤1.12, or ≤1.11.

In one embodiment, or a combination of two or more embodiments, each described herein, the composition comprises ≤10 wt %, or ≤5.0 wt %, or ≤2.0 wt %, or ≤1.0 wt %, or ≤0.5 wt %, or ≤0.1 wt % of a filler, based on the weight of the composition; and further the composition does not comprise a filler.

In regard to the third and fourth aspects, in one embodiment, or a combination of two or more embodiments, each described herein, the thermal treatment takes place in air.

Also provided is a crosslinked composition formed from a composition of one or more embodiments as described herein, or from a process of one or more embodiments as described herein. Also provided is an article comprising at least one component formed from a composition of one or more embodiments as described herein, or from a crosslinked composition of one or more embodiments as described herein.

Multimodal Ethylene/Alpha-Olefin Interpolymers In one embodiment, the multimodal ethylene/alpha-olefin interpolymer comprises at least two ethylene/alpha-olefin interpolymer fractions. Each ethylene/alpha-olefin interpolymer fraction, independently, comprises, in polymerize form, ethylene, and an alpha-olefin. The alpha-olefin may be either an aliphatic or an aromatic compound. The alpha-olefin is preferably a C3-C20 aliphatic compound, more preferably a C3-C10 aliphatic compound, such as propylene, 1-butene, 1-hexene, and 1-octene. The distribution of the monomeric units, and in particular, the alpha-olefin, may be random, block, homogeneous, heterogeneous, etc. Preferably, multimodal interpolymer is a random interpolymer (i.e., comprises a random distribution of its monomeric constituents).

In one embodiment, the multimodal ethylene/alpha-olefin interpolymer results from the use of different catalysts, different catalyst configurations, or different reactor conditions. For example, the use of two catalysts in a one reactor, during a polymerization process to form two interpolymer fractions (an in-situ blend). The multimodal interpolymer may also result from a physical blend of at least two ethylene/alpha-olefin interpolymers. In one embodiment, the multimodal ethylene/alpha-olefin interpolymer is formed from one of the following: a) two catalysts in one reactor; or b) a single catalyst used in different polymerization conditions; or c) two catalysts, each used in a different polymerization condition; or d) a physical blend. In a further embodiment, the multimodal ethylene/alpha-olefin interpolymer is formed from one of the following: a) two catalysts in one reactor; or b) a single catalyst used in different polymerization conditions; and further from: a) two catalysts in one reactor.

### Tempo Compound (Component c)

A Tempo compound has the Structure IA, Structure IB or Structure IC, each as described herein. Example of Tempo compounds include, but are not limited to, bis-(2,2,6,6-tetramethyl-1-piperidinyloxy-4-yl) sebacate.

### Peroxides (Component b)

As used herein, a peroxide contains at least one oxygen-oxygen bond (O—O). Peroxides include, but are not limited to, dialkyl, diaryl, dialkaryl, or diaralkyl peroxide, having the same or differing respective alkyl, aryl, alkaryl, or aralkyl moieties, and further each dialkyl, diaryl, dialkaryl, or diaralkyl peroxide, having the same respective alkyl, aryl, alkaryl, or aralkyl moieties.

Exemplary organic peroxides include dicumyl peroxide (“DCP”); tert-butyl peroxybenzoate; di-tert-amyl peroxide (“DTAP”); bis(t-butyl-peroxy isopropyl)benzene (“BIPB”); isopropylcumyl t-butyl peroxide; t-butylcumylperoxide; di-t-butyl peroxide; 2,5-bis(t-butylperoxy)-2,5-dimethylhexane (“LUPEROX 101”); 2,5-bis(t-butylperoxy)-2,5-dimethylhexyne-3; 1,1-bis(t-butylperoxy)3,3,5-trimethylcyclohexane; isopropylcumyl cumylperoxide; butyl 4,4-di(tert-butylperoxy)valerate; di(isopropylcumyl) peroxide; 1,1-di-(tert-butylperoxy)-cyclohexane (“LUPEROX 331”); 1,1-di-(tert-amylperoxy)cyclohexane (“LUPEROX 531”); tert-butylperoxyacetate (“TBPA”); tert-amyl peroxyacetate (“TAPA”); tert-butylperoxy-2-ethylhexyl carbonate (“TBEC”); and mixtures of two or more thereof.

The peroxide may be a cyclic peroxide. Examples of cyclic peroxides include those derived from acetone, methylamyl ketone, methylheptyl ketone, methylhexyl ketone, methylpropyl ketone, methylbutyl ketone, diethyl ketone, methylethyl ketone, methyloctyl ketone, methylnonyl ketone, methyldecyl ketone, methylundecyl ketone and combinations thereof, among others. The cyclic peroxides can be used alone or in combination with one another. A number of cyclic peroxides are commercially available, for example, under the tradename TRIGONOX, such as 3,6,9-triethyl-3,6,9-trimethyl-1,4,7-triperoxonane.

### Additives

An inventive composition may comprise one or more additives. Additives include, but are not limited to, crosslinking coagents, blowing agents, anti-oxidants, UV stabilizers, colorants, processing aids (for example, zinc stearate) and fillers (low amounts).

Crosslinking coagents, include, but are not limited to, triallyl isocyanurate (TAIC), triallyl cyanurate (TAC), triallyl trimellitate (TATM), trimethylolpropane triacylate (TMPTA), trimethylolpropane trimethylacrylate (TMPTMA), 1,6-hexanediol diacrylate, pentaerythritol tetraacrylate, dipentaerythritol penta acrylate, tris-(2-hydroxy ethyl) isocyanurate triacrylate, trivinyl cyclohexane (TVCH), or combinations thereof. Additional coagents include alkenyl-functional monocyclic organosiloxanes, as disclosed in WO 2019/000311 and WO 2019/000654, which are incorporated herein by reference in their entirety (for example, a monocyclic organosiloxane of the formula [R1, R2SiO2/2]n, wherein subscript n is an integer greater than or equal to 3; each R1 is independently a (C2-C4)alkenyl or a H₂C═C(R1a)—C(═O)—O—(CH₂)m- wherein R1a is H or methyl and subscript m is an integer from 1 to 4; and each R2 is independently H, (C₁-C₄)alkyl, phenyl, or R1; for example 2,4,6,8-tetramethyl-2,4,6,8-tetravinyl cyclotetrasiloxane, 2,4,6-trimethyl-2,4,6-trivinyl-cyclotrisiloxane, or a combination thereof).

In one embodiment, an additive is present in an amount 0.10, or ≥0.20, or ≥0.30, or ≥0.35, or 0.40 phr, based on 100 parts of component a, and/or ≤5.0, or ≤4.0, or ≤3.0, or ≤2.0, or ≤1.0 wt %, or 0.50 phr, based on 100 parts of component a.

### Definitions

Unless stated to the contrary, implicit from the context, or customary in the art, all parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to interpolymer that comprises, in polymerized form, 50 wt % or a majority weight percent of ethylene (based on the weight of the interpolymer), and an alpha-olefin.

The term, “ethylene/alpha-olefin copolymer,” as used herein, refers to a copolymer that comprises, in polymerized form, 50 wt % or a majority weight percent of ethylene (based on the weight of the copolymer), and an alpha-olefin, as the only two monomer types.

The term “multimodal” in the polymer term “multimodal ethylene/alpha-olefin interpolymer (or copolymer),” as used herein, refers to an interpolymer (or copolymer) that has a broad molecular weight distribution (MWD≥2.8, further ≥3.0). This broad MWD typically results from multiple interpolymer fractions present in the multimodal interpolymer (or copolymer). Each fraction of the interpolymer, for example, may result from the use of a different catalyst, a different catalyst configuration, or a different reactor condition in a polymerization process (each type of process results in an in-situ blend of two or more fractions). For example, the use of two catalysts in a one reactor, during a polymerization process to form two interpolymer fractions (an in-situ blend) Each fraction may also result from physical blends of multiple ethylene/alpha-olefin interpolymers, or from products from post-reactor chemical reaction to the polymers such as reactive extrusions. In one embodiment, the broad MWD results from an in-situ blend of two or more interpolymers (or copolymers) fractions or a physical blend or two or more interpolymers (or copolymers). In a further embodiment, the broad MWD results from an in-situ blend of two interpolymers (or copolymers) fractions or a physical blend or two interpolymers (or copolymers).

The phrase “a majority weight percent,” in reference to a polymer (or interpolymer or copolymer), refers to the amount of monomer present in the greatest amount in the polymer.

The term “heteroatom,” refers to an atom other than hydrogen or carbon (for example, O, S, N or P). The term “heteroatom group” refers to a heteroatom or a chemical group containing one or more heteroatoms.

The terms “hydrocarbon,” “hydrocarbyl,” and similar terms, as used herein, refer to a respective compound or chemical group, etc., containing only carbon and hydrogen atoms. A divalent “hydrocarbylene group” is defined in similar manner.

The terms “heterohydrocarbon,” “heterohydrocarbyl,” and similar terms, as used herein, refer to a respective hydrocarbon,” or “hydrocarbyl group, etc., in which at least one carbon atom is substituted with a heteroatom group (for example, O, S, N or P). The monovalent heterohydrocarbyl group may be bonded to the remaining compound of interest via a carbon atom or via a heteroatom. A divalent “heterohydrocarbylene group” is defined in similar manner; and the divalent heterohydrocarbylene group may be bonded to the remaining compound of interest via two carbon atoms, or two heteroatoms, or a carbon atom and a heteroatom.

The terms “substituted hydrocarbon,” “substituted hydrocarbyl group,” and similar terms, as used herein, refer to a respective hydrocarbon or hydrocarbyl group, etc., in which one or more hydrogen atoms is/are independently substituted with a heteroatom group. A “substituted hydrocarbylene group” is defined in similar manner.

The terms “substituted heterohydrocarbon,” “substituted heterohydrocarbyl group,” and similar terms, as used herein, refer to a respective heterohydrocarbon or heterohydrocarbyl group, etc., in which one or more hydrogen atoms is/are independently substituted with a heteroatom group. A “substituted heterohydrocarbylene group” is defined in similar manner.

The term “crosslinked composition,” as used herein, refers to a composition that has a network structure due to the formation of chemical bonds between polymer chains. The degree of formation of this network structure is indicated by an increase in the “MH-ML” differential, relative to the non-crosslinked composition. A crosslinked composition typically has a gel content ≥60 wt %, further ≥70 wt %, further ≥80 wt %, further ≥90 wt %, based on the weight of the crosslinked composition. Gel content may be determined by refluxing the crosslinked composition in xylene. For example, around 0.5 g of crosslinked composition (Ws) is sealed in a metal mesh (mesh number is 120), to form a packed sample, and the packed sample is weighed (Wt1). The packed sample is then transferred to a flask (500 ml), equipped with condenser, and containing 350 ml xylene. After refluxing for five hours, the packed samples is removed from xylene, and put into vacuum oven, and heated at 120° C., for two hours, under vacuum condition. After which time, the packed sample is removed from the oven, and weighed (Wt2). Gel content=1−[(Wt1−Wt2)/Ws]*100%.

The terms “thermally treating,” “thermally treated,” “thermal treatment,” and similar terms, as used herein, in reference to a composition as discussed herein, refer to increasing the temperature of the composition by the application of heat. As an example, heat may be applied by electrical means (for example, a heating coil) and/or by radiation and/or by hot oil and/or by mechanical shearing. Note, the temperature at which the thermal treatment takes place, refers to the temperature of the “heat-applying” device, or, if the device contains an enclosed or semi-enclosed atmosphere, the temperature of the atmosphere within the device, such as, for example, the atmosphere within an oven or a tunnel (for example, the air temperature in an hot air oven or a hot air tunnel).

The term “extrudate,” as used herein, refers to a polymer composition, typically in molten form, which exits an extruder.

The term “extruder configuration,” as used herein, refers to the arrangement and number of extruders (n≥1) used in an extrusion process. Typically, two or more extruders are arranged in a series orientation.

The term “average barrel temperature,” as used herein, in reference to an extrusion process using one or more extruders, each containing at least one barrel, refers to the average temperature of the sum of the barrel temperatures if two or more barrels are present, and if only one barrel is present, the temperature of this barrel.

The term “Garvey Die,” as used herein, in reference to an extrusion process, refers to a die of certain geometry that conforms to ASTM D2230-17, and which allows for the observation of the appearance and contours of an extrudate.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Compositions and Processes

A] A composition comprising the following components a) and b):
a) a first composition comprising a multimodal ethylene/alpha-olefin interpolymer, and wherein the first composition comprises the following properties: i) a density from 0.855 to 0.900 g/cc, ii) a [V100 (190° C.)]≤1000 Pa·s, iii) a [V0.1 (190° C.)/V100 (190° C.)]≥8.0,
b) at least one peroxide.
B] The composition of A] above, where the first composition has a V0.1 (190° C., Pa·s)≥3,000, or ≥3,200, or ≥3,400, or ≥3,600, or ≥4,000, or ≥4,500, or ≥5,000, and/or ≤30,000, or ≤25,000, or ≤20,000, or ≤18,000.
C] The composition of A] or B] above, where the first composition has a [V100 (190° C.), Pa·s]≤1000, or ≤950, or ≤900 and/or 300, or ≥350, or ≥400, or ≥450, or ≥500, or ≥550, or ≥600.
D] The composition of any one of A]-C] (A] through C]) above, wherein the first composition has a V0.1/V100 value≥9.0, or ≥10, or ≥11, or ≥12, or ≥13, and/or ≤50, or ≤40, or ≤35, or ≤30, or ≤25.
E] The composition of any one of A]-D] above, where the composition further comprises as component c, at least one Tempo compound of Structure I) as described herein (see I] below).
F] The composition of E] above, where the molar ratio of the NO from the at least one Tempo compound (component c) to the peroxide (O—O) bonds from the at least one peroxide (component b) is from 0.30 to 0.90.
G] The composition of E] or F] above, where component c is present in an amount from 0.20 to 0.90 phr, based on 100 parts of component a.
H] The composition of any one of A]-G] above, wherein the first composition has a melt index (I2, g/10 min or dg/min) 0.1, or ≥0.2, or ≥0.4, or ≥0.6, or ≥0.8, or ≥1.0 and/or ≤2000, or ≤1000, or ≤500, or ≤200, or ≤100, or ≤50, or ≤20, or ≤10, or ≤5.0.
I] A composition comprising the following components a) through c):
a) an first composition comprising a multimodal ethylene/alpha-olefin interpolymer, and wherein the first composition comprises the following properties: i) a density from 0.855 to 0.900 g/cc, ii) a [V0.1 (190° C.)/V100 (190° C.)]≥5.0,
b) at least one peroxide,
c) at least one Tempo compound of Structure I) selected from Structure IA, Structure IB or Structure IC, each as follows:
   Structure IA is

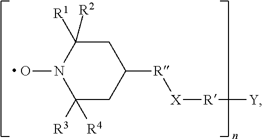

wherein n is an integer≥1;
R1, R2, R3 and R4 are each independently selected from H or a C1-C18 alkyl;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—N(R)—), urethane (—O—C(O)—NH— or —NH—C(O)—O—), carbamide (—NH—C(O)—NH—), or imide (—C(O)—N(R)—C(O)—);
R′ is selected from a C1-C30 alkylene;
R″ may or may not be present, and if present, R″ is selected from a C1-C30 alkylene;
Y is selected from CR₄₋ₙ where n=1 to 4, OR₂₋ₙ where n=1 to 2, NR₃₋ₙ where n=1 to 3, SR₂₋ₙ where n=1 to 2, PR₃₋ₙ where n=1 to 3, PR₅₋ₙ where n=1 to 5, SiR₄₋ₙ where n=1 to 4, a bifunctional C—C core, a phenyl core, a phenyl core substituted with ester, a phenyl core substituted with amide, a tris-isocyanurate core, or a melamine core; and
wherein the bifunctional C—C core is selected from the following structures, where each R′ represents the divalent R′ group in Structure IA above:

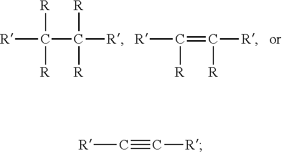

wherein the phenyl core is selected from the following structures, where each R′ represents the divalent R′ group in Structure IA above:

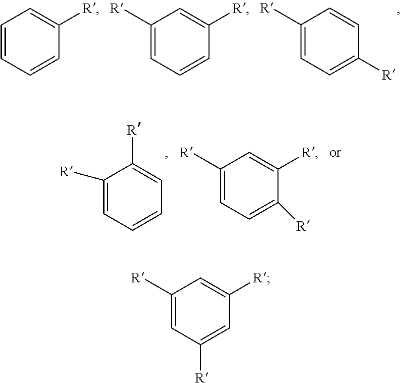

the phenyl core substituted with ester is selected from the following structures, where each R′ represents the divalent R′ group in Structure IA above:

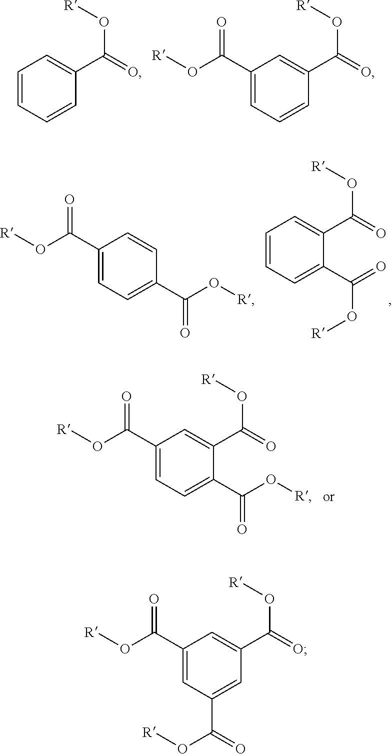

the phenyl core substituted with amide is selected from the following structures, where each R′ represents the divalent R′ group in Structure IA above:

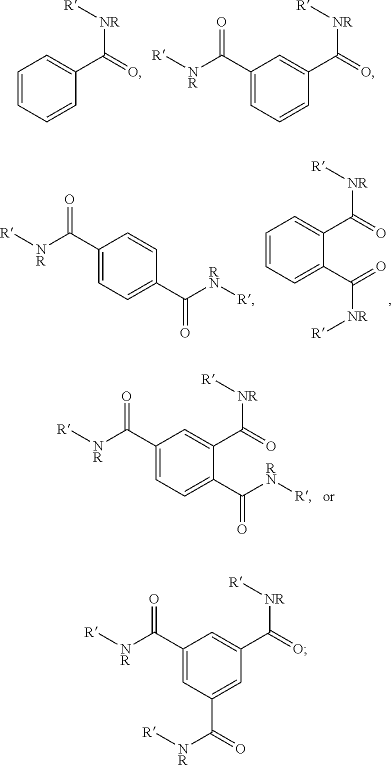

the tris-isocyanurate core is as follows, where each R′ represents the divalent R′ group in Structure IA above;

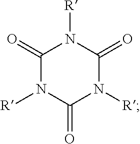

the melamine core is as follows, where each R′ represents the divalent R′ group in Structure IA above;

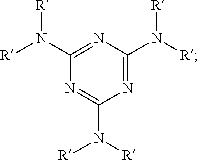

and
wherein each R group in Structure IA is independently selected from H, an unsubstituted hydrocarbyl, a substituted hydrocarbyl, an unsubstituted heterohydrocarbyl or a substituted heterohydrocarbyl;
Structure TB comprises sub-structure e) as follows:

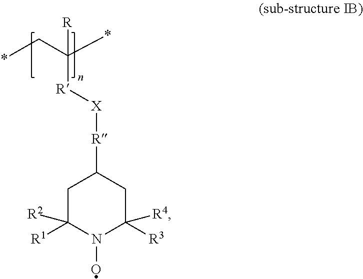

wherein n is an integer≥1;
R1, R2, R3 and R4 are each independently selected from H or a C1-C18 alkyl;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—N(R)—), urethane (—O—C(O)—NH— or —NH—C(O)—O—), carbamide (—NH—C(O)—NH—), or imide (—C(O)—N(R)—C(O)—;
R′ is selected from a C1-C30 alkylene;
R″ may or may not be present, and if present, R″ is selected from a C1-C30 alkylene;
each R group in sub-structure TB is independently selected from H, an unsubstituted hydrocarbyl, a substituted hydrocarbyl, an unsubstituted heterohydrocarbyl or a substituted heterohydrocarbyl;
each * (asterisk) in sub-structure IB represents the respective chemical end of Structure IB;
Structure IC comprises sub-structure IC) as follows:

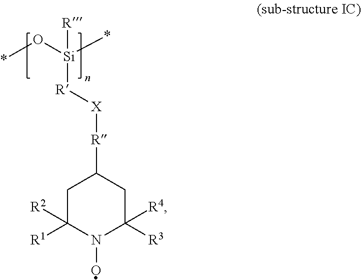

wherein n is an integer≥1;
R1, R2, R3 and R4 are each independently selected from H or a C1-C18;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—NO—), urethane (—O—C(O)—NH— or —NH—C(O)—O—), carbamide (—NH—C(O)—NH—), or imide (—C(O)—N(R)—C(O)—;
R′ is selected from a C1-C30 alkylene;
R″ may or may not be present, and if present, R″ is selected from a C1-C30 alkylene;
each R″′ group in sub-structure IC is independently selected from an unsubstituted hydrocarbyl, a substituted hydrocarbyl, an unsubstituted heterohydrocarbyl or a substituted heterohydrocarbyl;
each R group in sub-structure IC is independently selected from H, an unsubstituted hydrocarbyl, a substituted hydrocarbyl, an unsubstituted heterohydrocarbyl or a substituted heterohydrocarbyl;
each * (asterisk) in sub-structure IC represents the respective chemical end of Structure IC, and if n≥3, then each end may or may not form a cyclic structure with the other end.
J] The composition of I] above, where the first composition has a melt index (I2, g/10 min)≤5.0, or ≤4.8, or ≤4.6 and/or ≥0.1, or ≥0.2, or ≥0.4, or ≥0.6, or ≥0.8, or ≥1.0.
K] The composition of I] or J] above, wherein the first composition has a V0.1/V100 value≥5.5, or ≥6.0, or ≥6.5, or ≥7.0, or ≥7.5, or ≥8.0 and/or ≤50, or ≤40, or ≤35, or ≤30, or ≤25.
L] The composition of any one of I]-K] above, where the molar ratio of the NO from the at least one Tempo compound (component c) to the peroxide (O—O) bonds from the at least one peroxide (component b) is from 0.30 to 0.90.
M] The composition of any one of I]-L] above, where component c is present in an amount from 0.20 to 0.90 phr, based on 100 parts of component a.
N] The composition of any one of A]-M] above, wherein the multimodal ethylene/alpha-olefin interpolymer is selected from a multimodal ethylene/alpha-olefin copolymer.
O] The composition of any one of A]-N] above, wherein the multimodal ethylene/alpha-interpolymer is an in-situ blend or a physical blend.
P] The composition of any one of A]-O] above, wherein the multimodal ethylene/alpha-olefin interpolymer is an in-situ blend of two or more, and further two, multimodal ethylene/alpha-olefin interpolymers; and further two or more, and further two, multimodal ethylene/alpha-olefin copolymers.
Q] The composition of any one of A]-P] above, wherein the alpha-olefin of the multimodal ethylene/alpha-olefin interpolymer is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
R] The composition of any one of A]-Q] above, wherein the multimodal ethylene/alpha-olefin interpolymer does not comprise, in polymerized form, ENB, and further a diene monomer, and further a polyene monomer.
S] The composition of any one of A]-R] above, wherein the multimodal ethylene/alpha-olefin interpolymer has a density 0.856, or ≥0.860, or ≥0.862, or ≥0.864, or ≥0.866, or ≥0.868 g/cc and/or 0.898, or ≤0.896, or ≤0.894, or ≤0.892, or ≤0.890, or ≤0.888, or ≤0.886, or ≤0.884, or ≤0.882, or ≤0.880, or ≤0.878, or ≤0.876, or ≤0.874, or ≤0.872 g/cc.
T] The composition of any one of A]-S] above, wherein the multimodal ethylene/alpha-olefin interpolymer (of component a) has a total unsaturation 0.20/1000C, or 0.25/1000C, or 0.30/1000C, or ≥0.35/1000C, or ≥0.40/1000C, or 0.45/1000C, or ≥0.50/1000C, or ≥0.51/1000C, or ≥0.52/1000C, or ≥0.53/1000C and/or ≤15.0/1000C, or ≤10.0/1000C, or ≤5.00/1000C, or ≤2.00/1000C, ≤1.50/1000C, ≤1.20/1000C, or ≤1.00/1000C.
A2] A process to form a crosslinked composition, the process comprising thermally treating a composition comprising the following components a) and b):
a) a first composition comprising a multimodal ethylene/alpha-olefin interpolymer, and wherein the first composition comprises the following properties: i) a density from 0.855 to 0.900 g/cc, ii) a V100 (190° C.)≤1000 Pa·s, iii) a [V0.1 (190° C.)/V100 (190° C.)]≥8.0,
b) at least one peroxide.
B21 The process of A2] above, where the first composition has a V0.1 (190° C.)≥3,000, or ≥3,200, or ≥3,400, or ≥3,600, or ≥4,000, or ≥4,500, or ≥5,000 Pa·s, and/or ≤30,000, or ≤25,000, or ≤20,000, or ≤18,000.
C2] The process of A2] or B2] above, where the first composition has a [V100 (190° C.), Pa·s]950, or ≥900 and/or ≥300, or ≥350, or ≥400, or ≥450, or ≥500, or ≥550, or ≥600.
D2] The process of any one of A2]-C2] above, wherein the first composition has a V0.1/V100 value≥9.0, or ≥10, or ≥11, or ≥12, or ≥13, and/or ≤50, or ≤40, or ≤35, or ≤30, or ≤25.
E21 The process of any one of A2]-D2] above, where the composition further comprises as component c, at least one Tempo compound of Structure I) as described herein (see I] above).
F2] The process of E2] above, where the molar ratio of the NO from the at least one Tempo compound (component c) to the peroxide (O—O) bonds from the at least one peroxide (component b) is from 0.30 to 0.90.
G2] The process of E2] or F2] above, where component c is present in an amount from 0.20 to 0.90 phr, based on 100 parts of component a.
H2] The process of any one of A2]-G2] above, wherein the first composition has a melt index (I2, g/10 min) 0.1, or ≥0.2, or ≥0.4, or ≥0.6, or ≥0.8, or ≥1.0 and/or ≤2000, or ≤1000, or ≤500, or ≤200, or ≤100, or ≤50, or ≤20, or ≤10, or ≤5.0.
I2] A process to form a crosslinked composition, the process comprising thermally treating a composition comprising the following components a) through c):
a) an first composition comprising a multimodal ethylene/alpha-olefin interpolymer, and wherein the first composition comprises the following properties:
i) a density from 0.855 to 0.900 g/cc, ii) a [V0.1 (190° C.)/V100 (190° C.)]≥5.0,
b) at least one peroxide,
c) at least one Tempo compound of Structure I) selected from Structure IA, Structure IB or Structure IC, each as described herein (see I] above).
J2] The process of I2] above, where the first composition has a melt index (I2, g/10 min)≤5.0, or ≤4.8, or ≤4.6 and/or 0.1, or ≥0.2, or ≥0.4, or ≥0.6, or ≥0.8, or ≥1.0.
K2] The process of I2] or J2] above, wherein the first composition has a V0.1/V100 value≥5.5, or ≥6.0, or ≥6.5, or ≥7.0, or ≥7.5, or ≥8.0 and/or ≤50, or ≤40, or ≤35, or ≤30, or ≤25.
L2] The process of any one of I2]-K2] above, where the molar ratio of the NO from the at least one Tempo compound (component c) to the peroxide (O—O) bonds from the at least one peroxide (component b) is from 0.30 to 0.90.
M2] The process of any one of I2]-L2] above, where component c is present in an amount from 0.20 to 0.90 phr, based on 100 parts of component a.
N2] The process of any one of A2]-M2] above, wherein the thermal treatment takes place in air; and further at a temperature from 150° C. to 240° C.
O2] The process of any one of A2]-N2] above, where the process comprising at least the following steps A and B:
   A) extruding the composition to form a pre-crosslinked composition, and
   B) thermally treating the pre-crosslinked composition in air, at a temperature≥150° C., to form the crosslinked composition.
P2] The process of O2] above, wherein, for step A, the composition is extruded at an average barrel temperature≥50° C., or ≥55° C., or ≥60° C., or ≥65° C., or ≥70° C., or ≥75° C., or ≥80° C., or ≥85° C., or ≥90° C., or ≥95° C., or ≥100° C., or ≥105° C., or ≥110° C. and/or ≤140° C., or 135° C., or 130° C., or 125° C., or ≤120° C., or 115° C.
Q2] The process of O2] or P2] above, wherein, for step B, the pre-crosslinked composition is thermally treated at a temperature≥150° C., or ≥155° C., or ≥160° C., or ≥165° C., or ≥170° C., or ≥175° C., or ≥180° C., or ≥185° C., or ≥190° C., or ≥195° C. and/or ≤240° C., or ≤235° C., or ≤230° C., or ≤225° C., or ≤220° C., or ≤215° C., or ≤210° C., or ≤205° C., or ≤200° C.
R2] The process of any one of O2]-Q2] above, wherein, for step B, the pre-crosslinked composition is thermally treated in a continuous hot oven or a CV tunnel.
S2] The process of any one of O2]-R2] above, wherein, for step A, the composition is extruded in an extruder configuration, in series, which comprises a Garvey Die at the end of the last extruder in the extruder configuration.

T2] The process of any one of A2]-S2] above, wherein the multimodal ethylene/alpha-olefin interpolymer is selected from a multimodal ethylene/alpha-olefin copolymer.
U2] The process of any one of A2]-T2] above, wherein the multimodal ethylene/alpha-olefin interpolymer is an in-situ blend or a physical blend.
V2] The process of any one of A2]-U2] above, wherein the multimodal ethylene/alpha-olefin interpolymer is an in-situ blend of two or more, and further two, multimodal ethylene/alpha-olefin interpolymers; and further two or more, and further two, multimodal ethylene/alpha-olefin copolymers.
W21 The process of any one of A2]-V2] above, wherein the alpha-olefin of the multimodal ethylene/alpha-olefin interpolymer is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
X2] The process of any one of A2]-W2] above, wherein the multimodal ethylene/alpha-olefin interpolymer does not comprise, in polymerized form, ENB, and further a diene monomer, and further a polyene monomer.
Y2] The process of any one of A2]-X2] above, wherein the multimodal ethylene/alpha-olefin interpolymer has a density≥0.856, or ≥0.860, or ≥0.862, or ≥0.864, or ≥0.866, or ≥0.868 g/cc, and/or ≤0.898, or ≤0.896, or ≤0.894, or ≤0.892, or ≤0.890, or ≤0.888, or ≤0.886, or ≤0.884, or ≤0.882, or ≤0.880, or ≤0.878, or ≤0.876, or ≤0.874, or ≤0.872 g/cc.
Z2] The process of any one of A2]-Y2] above, wherein the multimodal ethylene/alpha-olefin interpolymer (of component a) has a total unsaturation≥0.20/1000C, or ≥0.25/1000C, or ≥0.30/1000C, or ≥0.35/1000C, or ≥0.40/1000C, or ≥0.45/1000C, or ≥0.50/1000C, or ≥0.51/1000C, or 0.52/1000C, or ≥0.53/1000C and/or ≤15.0/1000C, or ≤10.0/1000C, or ≤5.00/1000C, or ≤2.00/1000C, ≤1.50/1000C, ≤1.20/1000C, or ≤1.00/1000C.
A4] The composition of any one of A]-T] above, or the process of any one of A2]-Z2] above, wherein the multimodal ethylene/alpha-olefin interpolymer of component a has a number average molecular weight Mn≥6,000, or ≥8,000, or ≥10,000, or ≥12,000, or ≥14,000, or ≥16,000, or ≥18,000, or ≥20,000 g/mol, and/or ≤120,000, or ≤100,000, or ≤80,000, or ≤70,000, or ≤60,000, or ≤50,000, or ≤45,000, or ≤40,000, or ≤35,000 g/mol.
B4] The composition of any one of A]-T] or A4] above, or the process of any one of A2]-Z2] or A4] above, wherein the multimodal ethylene/alpha-olefin interpolymer of component a has a weight average molecular weight Mw≥20,000, or ≥30,000, or ≥40,000, or ≥50,000, or ≥60,000, or ≥70,000 g/mol, and/or ≤150,000, or ≤145,000, or ≤140,000, or ≤135,000, or ≤130,000, or ≤125,000, or ≤120,000, or ≤115,000 g/mol.
C41 The composition of any one of A]-T], A4] or B4] above, or the process of any one of A2]-Z2], A4] or B4] above, wherein the multimodal ethylene/alpha-olefin interpolymer of component a has a molecular weight distribution MWD (=Mw/Mn)≥2.80, or ≥2.90, or ≥3.00 and/or ≤5.00, or ≤4.50, or ≤4.00 or ≤3.80, or ≤3.70, or ≤3.60, or ≤3.50.
D4] The composition of any one of A]-T] or A4]-C4] above, or the process of any one of A2]-Z2] or A4]-C4] above, wherein component a further comprises second multimodal ethylene/alpha-olefin interpolymer with a density from 0.855 to 0.900 g/cc, and a total unsaturation≥0.20/1000C, and this second interpolymer is different from the multimodal ethylene/alpha-olefin interpolymer, and further different in one or more features selected from density, total unsaturation, melt index (I2), or any combination therein.
E41 The composition of D4] above or the process of D4] above, wherein the second multimodal ethylene/alpha-olefin interpolymer has a density≥0.856, or ≥0.860, or ≥0.862, or ≥0.864, or ≥0.866, or ≥0.868 g/cc, and/or ≤0.898, or ≤0.896, or ≤0.894, or ≤0.892, or ≤0.890, or ≤0.888, or ≤0.886, or ≤0.884, or ≤0.882, or ≤0.880, or ≤0.878, or ≤0.876, or ≤0.874, or ≤0.872 g/cc, or ≤0.870 g/cc.
F4] The composition of D4] or E4] above or the process of D4] or E4] above, wherein the second multimodal interpolymer has a total unsaturation≥0.20/1000C, or ≥0.25/1000C, or ≥0.30/1000C, or ≥0.35/1000C, or ≥0.40/1000C, or ≥0.45/1000C, or ≥0.50/1000C, or ≥0.51/1000C, or ≥0.52/1000C, or ≥0.53/1000C and/or ≤15.0/1000C, or ≤10.0/1000C, or ≤5.00/1000C, or ≤2.00/1000C, ≤1.50/1000C, ≤1.20/1000C, or ≤1.00/1000C.
G4] The composition of any one of D4]-F4] above, or the process of any one of D4]-F4] above, wherein the second multimodal ethylene/alpha-olefin interpolymer has a melt index (I2, g/10 min or dg/min)≥0.1, or ≥0.2, or ≥0.5, or ≥0.8, or ≥1.0, and/or ≤2000, or ≤1000, or ≤500, or ≤200, or ≤100, or ≤50, or ≤20, or ≤10, or ≤5.0, or ≤2.0.
H4] The composition of any one of D4]-G4] above, or the process of any one of D4]-G4] above, wherein the second multimodal ethylene/alpha-olefin interpolymer is a multimodal ethylene/alpha-olefin copolymer.
I4] The composition of any one of D4]-H4] above, or the process of any one of D4]-H4] above, wherein the second multimodal ethylene/alpha-olefin interpolymer is an in-situ blend or a physical blend.
J4] The composition of any one of D4]-I4] above, or the process of any one of D4]-I4] above, wherein the second multimodal ethylene/alpha-olefin interpolymer is an in-situ blend of two or more, and further two, multimodal ethylene/alpha-olefin interpolymers; and further two or more, and further two, multimodal ethylene/alpha-olefin copolymers.
K4] The composition of any one of D4]-J4] above, or the process of any one of D4]-J4] above, wherein the alpha-olefin of the second multimodal ethylene/alpha-olefin interpolymer is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
L4] The composition of any one of D4]-K4] above, or the process of any one of D4]-K4] above, wherein the second multimodal ethylene/alpha-olefin interpolymer does not comprise, in polymerized form, ENB, and further a diene monomer, and further a polyene monomer.
M4] The composition of any one of D4]-L4] above, or the process of any one of D4]-L⁴]above, wherein the ratio of the density of the multimodal ethylene/alpha-olefin interpolymer to the density of the second multimodal ethylene/alpha-olefin interpolymers is ≥0.80, or ≥0.85, or ≥0.90, or ≥0.92, or ≥0.94, or ≥0.96, or ≥0.98 or ≥1.00, and/or ≤1.25, or ≤1.20, or ≤1.18, or ≤1.16, or ≤1.14, or ≤1.12, or ≤1.11.
N4] The composition of any one of D4]-M4] above, or the process of any one of D4]-M4] above, wherein the ratio of the total unsaturation of the multimodal ethylene/alpha-olefin interpolymer to the total unsaturation of the second multimodal ethylene/alpha-olefin interpolymer is ≥0.8, or ≥0.9, or ≥1.0, or ≥1.1 and/or ≤5.0, or ≤4.5, or ≤4.0, or ≤3.5, or 3.0, or ≤2.5, or ≤2.0, or ≤1.5.
O4] The composition of any one of D4]-N4] above, or the process of any one of D4]-N4] above, wherein the ratio of the melt index (I2) of the multimodal ethylene/alpha-olefin interpolymer to the melt index (I2) of the second multimodal ethylene/alpha-olefin interpolymer is ≥0.8, or ≥1.0, or ≥2.0, or ≥2.5, or ≥3.0, or ≥3.5, or ≥4.0 and/or ≤20, or ≤10, or ≤8.0, or ≤6.0, or ≤5.0.
P4] The composition of any one of D4]-04] above, or the process of any one of D4]-04] above, wherein the weight ratio of the ethylene/alpha-olefin interpolymer to the second ethylene/alpha-olefin interpolymer is ≥0.50, or ≥0.60, or ≥0.70, or ≥0.80, or ≥0.90, or ≥1.0 and/or ≤20, or ≤10, or ≤8.0, or ≤6.0, or ≤4.0, or ≤2.0, or ≤1.5, or ≤1.2.
Q4] The composition of any one of D4]-P4] above, or the process of any one of D4]-P4] above, wherein component a comprises ≥80.0 wt %, or ≥85.0 wt %, or ≥90.0 wt %, or ≥95.0 wt %, or ≥98.0 wt %, or ≥99.0 wt %, or ≥99.5 wt %, and/or ≤100.0 wt %, or ≤99.9 wt %, or ≤99.8 wt %, of the sum of the multimodal ethylene/alpha-olefin interpolymer and the second multimodal ethylene/alpha-olefin interpolymers, based on the weight of component a.
R4] The composition of any one of A]-T] or A4]-C4] above, or the process of any one of A2]-Z2] or A4]-C4] above, wherein component a comprises ≥80.0 wt %, or ≥85.0 wt %, or ≥90.0 wt %, or ≥95.0 wt %, or ≥98.0 wt %, or ≥99.0 wt %, or ≥99.5 wt % and/or ≤100.0 wt %, or ≤99.9 wt %, or ≤99.8 wt %, of the multimodal ethylene/alpha-olefin interpolymer, based on the weight of component a.
S4] The composition of any one of A]-T] or A4]-R4] above, or the process of any one of A2]-Z2] or A4]-R4] above, wherein, for the Structure I of component c, each of R1, R2, R3, and R4 is the same.
T4] The composition of any one of A]-T] or A4]-R4] above, or the process of any one of A2]-Z2] or A4]-R4] above, wherein, for Structure I of component c, at least one of R1, R2, R3 and R4 is different than the others of R1, R2, R3 and R4.
U4] The composition of any one of A]-T] or A4]-R4] above, or the process of any one of A2]-Z2] or A4]-R4] above, wherein, for Structure I of component c, each of R1, R2, R3 and R4 is, independently, selected from H or a C1-C5 alkyl, further H or a C₁-C₄ alkyl, further H or a C₁-C₃ alkyl, further H or a C1-C2 alkyl, further H or a methyl.
V4] The composition of any one of A]-T] or A4]-R4] above, or the process of any one of A2]-Z2] or A4]-R4] above, wherein, for Structure I of component c, each of R1, R2, R3 and R4 is, independently, selected from a C₁-C₆ alkyl, further a C₁-C₅ alkyl, further a C₁-C₄ alkyl, further a C₁-C₃ alkyl, further a C1-C2 alkyl, further a methyl.
W4] The composition of any one of A]-T] or A4]-V4] above, or the process of any one of A2]-Z2] or A4]-V4] above, wherein, for Structure I of component c, X is selected from CH₂, ether (—O—), carbonyl (—C(O)—), ester (—O—C(O)— or —C(O)—O—), amine (—N(R)—), or amide (—N(R)—C(O)— or —C(O)—N(R)—), and further CH₂, ether (—O—) or ester (—O—C(O)— or —C(O)—O—), and further ester (—O—C(O)— or —C(O)—O—).
X4] The composition of any one of A]-T] or A4]-W4] above, or the process of any one of A2]-Z2] or A4]-W4] above, wherein, for Structure I of component c, R′ selected from a C1-C6 alkylene, further a C₁-C₅ alkylene, further a C1-C4 alkylene, further a C₁-C₃ alkylene, further a C1-C2 alkylene.
Y4] The composition of any one of A]-T] or A4]-X4] above, or the process of any one of A2]-Z2] or A4]-X4] above, wherein, for Structure I of component c, R″ selected from a C1-C6 alkylene, further a C₁-C₅ alkylene, further a C1-C4 alkylene, further a C₁-C₃ alkylene, further a C1-C2 alkylene, and further methylene.
Z4] The composition of any one of A]-T] or A4]-X4] above, or the process of any one of A2]-Z2] or A4]-X4] above, wherein, for Structure I of component c, R″ is not present.
A5] The composition of any one of A]-T] or A4]-Z4] above, or the process of any one of A2]-Z2] or A4]-Z4] above, wherein, for Structure I of component c, n≥2.
B5] The composition of any one of A]-T] or A4]-A5] above, or the process of any one of A2]-Z2] or A4]-A5] above, wherein Structure I (component c) is selected from Structure IA.
C5] The composition of any one of B5] above, or the process of any one of P2] above, wherein, for Structure IA, n is from 2 to 4, further from 2 or 3, further 2.
D5] The composition of B5] or C5] above, or the process of B5] or C5] above, wherein, for Structure IA, Y is selected from CR₄₋ₙ where n=1 to 4, OR₂₋ₙ where n=1 to 2, NR₃₋ₙ where n=1 to 3, a bifunctional C—C core as described herein, a phenyl core as described herein, a phenyl core substituted with ester as described herein, a phenyl core substituted with amide as described herein, and further from CR₄₋ₙ where n=1 to 4, OR₂₋ₙ where n=1 to 2, NR₃₋ₙ where n=1 to 3, a bifunctional C—C core as described herein, or a phenyl core as described herein, and further from CR₄₋ₙ where n=1 to 4, OR₂₋ₙ where n=1 to 2 or a bifunctional C—C core as described herein, and further from CR₄₋ₙ where n=1 to 4 or a bifunctional C—C core as described herein, and further from a bifunctional C—C core as described herein.
E5] The composition of D5] above, or the process of D5] above, wherein the bifunctional C—C core is selected from

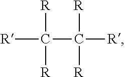

where each R′ represents the divalent R′ group in Structure IA above′ and further each R of the C—C core is H.
F51 The composition of any one of B5]-E5] above, or the process of any one of B5]-E5] above, wherein, for Structure IA, each R is independently selected from an H, an unsubstituted hydrocarbyl, or a substituted hydrocarbyl, and further H or an unsubstituted hydrocarbyl, and further H or an alkyl, and further H or a C1-C5 alkyl.
G5] The composition of any one of B5]-F5] above, or the process of any one of B5]-F5] above, wherein Structure IA is Structure IA1 below:

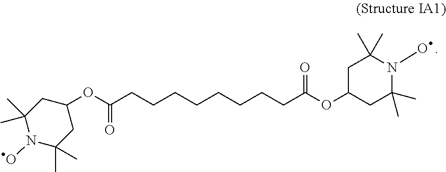 [SMILES: CC1(C)CC(OC(=O)CCCCCCCCC(=O)OC2CC(C)(C)N(O)C(C)(C)C2)CC(C)(C)N1O]

H5] The composition of any one of A]-T] or A4]-A5] above, or the process of any one of A2]-Z2] or A4]-A5] above wherein Structure I (component c) is selected from Structure IB, which comprises sub-structure IB.
I5] The composition of H5] above, or the process of H5] above, wherein, for sub-structure IB, n≥10, or n≥20, or n≥50, or n≥100.
J5] The composition of H5] or I5] above, or the process of H5] or I5] above, wherein, for sub-structure IB, each R group is independently selected from an H, an unsubstituted hydrocarbyl, or a substituted hydrocarbyl, and further H or an unsubstituted hydrocarbyl, and further H or an alkyl, and further H or a C1-C5 alkyl.
K5] The composition of any one of A]-T] or A4]-A5] above, or the process of any one of A2]-Z2] or A4]-A5] above, wherein Structure I (component c) is selected from Structure IC, which comprises sub-structure IC.
L5] The composition of K5] above, or the process of K5] above, wherein, for sub-structure IC, n≥10, or n≥20, or n≥50, or n≥100.
M5] The composition of K5] or L⁵] above, or the process of K5] or L⁵] above, wherein, for sub-structure IC, each R group is independently selected from an H, an unsubstituted hydrocarbyl, or a substituted hydrocarbyl, and further H or an unsubstituted hydrocarbyl, and further H or an alkyl, and further H or a C1-C5 alkyl.
N5] The composition of any one of K5]-M5] above, or the process of any one of K5]-M5] above, wherein, for sub-structure IC, each R″′ group is independently selected from an unsubstituted hydrocarbyl, or a substituted hydrocarbyl, and further an unsubstituted hydrocarbyl, and further an alkyl, and further a C1-C5 alkyl.
O5] The composition of any one of K5]-N5] above, or the process of any one of K5]-N5] above, wherein, for sub-structure IC, n≥3 and each end * (asterisk) forms a cyclic structure with the other end.
P5] The composition of any one of E]-T] or A4]-05] above, or the process of any one of E2]-Z2] or A4]-05] above, wherein the molar ratio of the NO from the Tempo compound to the peroxide (O—O) bonds is ≥0.31, or ≥0.33, or ≥0.34 and/or ≤0.88, or ≤0.85, or ≤0.82, or ≤0.80, or ≤0.78, or ≤0.75, or ≤0.72, or ≤0.70, or ≤0.68, or ≤0.65, or ≤0.62, or ≤0.60, or ≤0.58.
Q5] The composition of any one of E]-T] or A4]-P5] above, or the process of any one of E2]-Z2] or A4]-P5] above, wherein component c is present in an amount ≥0.22, or ≥0.25, or ≥0.28, or ≥0.30, or ≥0.32, or ≥0.35, or ≥0.38, or ≥0.40, or ≥0.42 or ≥0.45 phr and/or ≤0.88, or ≤0.85, or ≤0.82, or ≤0.80, or ≤0.78, or ≤0.75 phr, based on 100 parts of component a.
R5] The composition of any one of A]-T] or A4]-Q5] above, or the process of any one of A2]-Z2] or A4]-Q5] above, wherein component b is present in an amount ≥0.20, or ≥0.40, or ≥0.60, or ≥0.80 phr and/or ≤2.0, or ≤1.8, or ≤1.6 phr, based on 100 parts of component a.
S5] The composition of any one of A]-T] or A4]-R5] above, or the process of any one of A2]-Z2] or A4]-R5] above, wherein composition comprises ≥90.0 wt %, or ≥91.0 wt %, or ≥92.0 wt %, or ≥93.0 wt %, or ≥94.0 wt % or ≥95.0 wt % and/or ≤100.0 wt %, or ≤99.5 wt %, or ≤99.0 wt %, or ≤98.7 wt % of component a based on the weight of the composition.
T5] The composition of any one of A]-T] or A4]-S5] above, or the process of any one of A2]-Z2] or A4]-S5] above, wherein the composition further comprises a crosslinking coagent (component d).
U5] The composition of T5] above, or the process of T5] above, wherein component d is present in an amount ≥0.05, or ≥0.10, or ≥0.15, or ≥0.20, or ≥0.22, or ≥0.25, or ≥0.30, or ≥0.35, or ≥0.38 or ≥0.40 phr and/or ≤1.0, or ≤0.80, or ≤0.75, or ≤0.70, or ≤0.65, or ≤0.60, or ≤0.55, or ≤0.50, or ≤0.48, or ≤0.45 phr based on 100 parts of component a.
V5] The composition of any one of E]-T] or A4]-U5] above, or the process of any one of E2]-Z2] or A4]-U5] above, wherein the weight ratio of component c to component b is ≥0.20, or ≥0.25, or ≥0.30, or ≥0.35, or ≥0.40, or ≥0.45, or ≥0.50, or ≥0.55, or ≥0.57 and/or ≤5.0, or ≤4.0, or ≤3.0, or ≤2.0, or ≤1.5, or ≤1.0, or ≤0.80, or ≤0.70, or ≤0.65.
W5] The composition of any one of A]-T] or A4]-V5] above, or the process of any one of A2]-Z2] or A4]-V5] above, wherein the composition comprises ≤10 wt %, or ≤5.0 wt %, or ≤2.0 wt %, or ≤1.0 wt %, or ≤0.5 wt %, or ≤0.1 wt % of a filler, based on the weight of the composition; and further the composition does not comprise a filler.
X5] The composition of any one of A]-T] or A4]-W5] above, or the process of any one of A2]-Z2] or A4]-W5] above, wherein composition comprises ≥94.0 wt %, or ≥94.5 wt %, or ≥95.0 wt % or ≥95.5 wt %, or ≥96.0 wt %, or ≥96.5 wt % and/or ≤100.0 wt %, or ≤99.5 wt %, or ≤99.0 wt %, or ≤98.5 wt % of the sum of components a and b, based on the weight of the composition.
Y5] The composition of any one of E]-T] or A4]-X5] above, or the process of any one of E2]-Z2] or A4]-X5] above, wherein composition comprises ≥95.0 wt %, or ≥95.5 wt %, or ≥96.0 wt % or ≥96.5 wt %, or ≥97.0 wt % and/or ≤100.0 wt %, or ≤99.5 wt %, or ≤99.0 wt % of the sum of components a, b and c, based on the weight of the composition.
Z5] The composition of any one of E]-T] or A4]-Y⁵] above, or the process of any one of E2]-Z2] or A4]-Y⁵] above, wherein composition comprises one Tempo compound for component c.
A6] The composition of any one of A]-T] or A4]-Z5] above, or the process of any one of A2]-Z2] or A4]-Z5] above, wherein composition comprises one peroxide for component b.
B6] The composition of any one of A]-T] or A4]-A6] above, or the process of any one of A2]-Z2] or A4]-A6] above, wherein the composition further comprises a polymer, different from the multimodal ethylene/alpha-olefin interpolymer of component a in one or more features, such as comonomer type, comonomer content, density, melt index (I2), total unsaturation, Mn, Mw, MWD, or any combination thereof, and further comonomer type, comonomer content, density, melt index (I2), total unsaturation, or any combination thereof
C6] The composition of any one of A]-T] or A4]-B6] above, or the process of any one of A2]-Z2] or A4]-B6] above, wherein the composition has a (MH-ML) value MH≥6.0, or ≥6.2, or ≥6.4 dNm, and/or ≤10, or ≤9.0, or ≤8.0 dNm, where the MH and ML values are determined in accordance with the MDR test described herein.
D6] The composition of any one of A]-T] or A4]-C6] above, or the process of any one of A2]-Z2] or A4]-C6] above, wherein the composition has a T90 value≥4.0, or ≥4.2, or ≥4.5 min, and/or ≤6.0, or ≤5.5 min, as determined by the MDR test described herein.
E6] The composition of any one of A]-T] or A4]-D6] above, or the process of any one of A2]-Z2] or A4]-D6] above, wherein the multimodal ethylene/alpha-olefin interpolymer is a random interpolymer, and further a random copolymer.
F61 The composition of any one of D4]-E6] above, or the process of any one of D4]-E6] above, wherein the second multimodal ethylene/alpha-olefin interpolymer is a random interpolymer, and further a random copolymer.
G6] A crosslinked composition formed from the composition of any one of A]-T] or D4]-F6] above, and further by thermally treating theses composition; or a crosslinked composition formed by the process of any one of A2]-Z2] or A4]-F6] above.
H6] An extrudate formed from the composition of any one of A]-T] or A4]-F6] above, or formed by the process of any one of A2]-Z2] or A4]-F6] above.
I16] The extrudate of H6] above, wherein the extrudate has a smooth surface.
J6] An article comprising at least one component formed from the composition of any one of A]-T] or A4]-F6] above, or formed by the process of any one of A2]-Z2] or A4]-F6].
K6] An article comprising at least one component formed from the crosslinked composition of G6] above.
L6] The article of J6] or K6] above, wherein the article is an automotive part or a building material, a footwear component, or a PV film, and further an automotive part.
M6] The article of J6] or K6] above, wherein the article is a profile.

### Test Methods

### Dynamic Mechanical Spectroscopy (DMS)

The viscosity of the first composition (polymer or blend) was measured using Dynamic Mechanical spectroscopy (DMS) analysis. DMS was performed using an Advanced Rheometric Expansion System (ARES) for melt state testing. The test used a “25 mm” parallel plates at 5% strain. The angular frequency from 0.1 to 100 rad/s at 190° C., recording 5 data points per decade. One sample was tested per composition. The V0.1, V100 and V0.1/V100 values were recorded.

### Melt Strength

The melt strength of first composition (polymer or blend; about 15 grams) was measured using the conditions in Table A below.

TABLE A
MS Conditions

| Wheels | Standard | |
|---|---|---|
| Gap | 0.4 | |
| Acceleration a * t | a = 2.4 | [mm/s²] |
| Temperature | 190.0 | [° C.] |
| Piston diameter | 12 | [mm] |
| Piston speed | 0.265 | [mm/s] |
| Die geometry | 30/2 | [mm] |
| Shear rate | 38.2 | [1/s] |
| Strand length | 100.0 | [mm] |
| V0 | 9.5 | [mm/s] |

### Moving Die Rheometer (MDR) Analysis

The MDR cure properties of each composition was measured in accordance with ASTM D-5289, using an Alpha Technologies MDR 2000. A “4.5 g sample” of a composition was cut from the “4 mm thick” sheet prepared from the two-mill (see experimental section), and placed into the MDR sample holder. The MDR test was carried out at 180° C., over a period of 15 minutes, at an oscillation frequency of 100 CPM (1.67 Hz) and an oscillation angle of 0.5 degree (7% strain). The minimum torque (ML) and the maximum torque (MH) exerted by the MDR during the testing interval are reported in dNm.

The difference between MH and ML, or MH-ML, is indicative of the extent of crosslinking, with the greater the difference reflecting a greater extent of crosslinking. The time it takes for torque to reach X % (for example, 90%) of the MH value, or the TX value (for example, T90), is reported in minutes. One sample tested per composition.

### Melt Index

The melt index 12 (or MI) of an ethylene-based polymer or blend (as used herein) is measured in accordance with ASTM D-1238, condition 190° C./2.16 kg. The melt flow rate MFR of a propylene-based polymer is measured in accordance with ASTM D-1238, condition 230° C./2.16 kg.

### Polymer Density

ASTM D4703 is used to make a polymer plaque for density analysis. ASTM D792, Method B, is used to measure the density of each polymer.

### ¹H NMR Method

Sample Preparation: Each sample was prepared by adding approximately 130 mg of sample to 3.25 g of a “50/50 by weight tetrachlorethane-d2/perchloroethylene (TCE-d2/PCE) with 0.001M Cr(AcAc)₃,” in a NORELL 1001-7, 10 mm, NMR tube. The sample was purged by bubbling N₂ through the solvent, via a pipette inserted into the tube, for approximately five minutes to prevent oxidation. The tube was then capped and sealed with TEFLON tape, before heating and vortex mixing at 115° C. to achieve a homogeneous solution.

Data Acquisition Parameters and Data Analysis: ¹H NMR was performed on a Bruker AVANCE 600 MHz spectrometer, equipped with a Bruker high-temperature CryoProbe, with a sample temperature of 120° C. Two experiments were run to obtain spectra, a control spectrum to quantitate the total polymer protons, and a double presaturation experiment, which suppresses the intense peaks associated with the polymer chains, and enables high sensitivity spectra for quantitation of the end-groups. The control was run with ZG pulse, 16 scans, AQ 1.82 s, D₁ (relaxation delay) 14 s. The double presaturation experiment was run with a modified pulse sequence, 1c1prf2.zz, 64 scans, AQ 1.82s, D₁ (presaturation time) 2s, D₁₃ (relaxation delay) 12s. Unsaturation measurements were made according to the following method. The area under the resonance from the polymer chains (i.e., CH, CH₂, and CH₃ in the polymers) was measured from the spectrum acquired during first experiment (the control spectrum), described above.

The unsaturation was analyzed with the method in Reference 3 noted below. Reference 1: Z. Zhou, R. Kuemmerle, J. C. Stevens, D. Redwine, Y. He, X. Qiu, R. Cong, J. Klosin, N. Montanez, G. Roof, Journal of Magnetic Resonance, 2009, 200, 328. Reference 2: Z. Zhou, R. Kummerle, X. Qiu, D. Redwine, R. Cong, A. Taha, D. Baugh, B. Winniford, Journal of Magnetic Resonance: 187 (2007) 225. Reference 3: Z. Zhou, R. Cong, Y. He, M. Paradkar, M. Demirors, M. Cheatham, W. deGroot, Macromolecular Symposia, 2012, 312, 88.

The peak areas for each type of observed unsaturation (i.e., vinyl, vinylidene, vinylene and trisubstituted was measured from the spectrum acquired during the second (presaturation) experiment described above. Both spectra were normalized to the solvent peak area. Moles of respective unsaturation were calculated by dividing the area under the unsaturation resonance by the number of protons contributing to that resonance. Moles of carbons in the polymers were calculated by dividing the area under the peaks for polymer chains (i.e., CH, CH₂, and CH₃ in the polymers) by two. The amount of total unsaturation (sum of the above unsaturations) was then expressed as a relative ratio of moles of total unsaturation to the moles of carbons in the polymers, with expression of the number of unsaturation per 1000 Carbon (per 1000 C).—Results are the same within <5% relative.

### Gel Permeation Chromatography—Ethylene-based Polymers

The chromatographic system consists of a PolymerChar GPC-IR (Valencia, Spain) high temperature GPC chromatograph, equipped with an internal infra-red detector (IR5). The autosampler oven compartment is set at 160° C., and the column compartment is set at 150° C. The columns are four AGILENT “Mixed A” 30 cm, 20-micron linear mixed-bed columns. The chromatographic solvent is 1,2,4-trichlorobenzene, which contains 200 ppm of butylated hydroxytoluene (BHT). The solvent source is nitrogen sparged. The injection volume is 200 microliters, and the flow rate is 1.0 milliliters/minute.

Calibration of the GPC column set is performed with 21 narrow molecular weight distribution polystyrene standards, with molecular weights ranging from 580 to 8,400,000 g/mol, and which are arranged in six “cocktail” mixtures, with at least a decade of separation between individual molecular weights. The standards are purchased from Agilent Technologies. The polystyrene standards are prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards are dissolved at 80° C., with gentle agitation, for 30 minutes. The polystyrene standard peak molecular weights are converted to polyethylene molecular weights using Equation 1 (as described in Williams and Ward, J. Polym. Sci., Polym. Let., 6, 621 (1968)):
M_{polyethylene}=A×(M_{polystyrene})^{B} (EQ1), where M is the molecular weight, A has a value of 0.4315 and B is equal to 1.0.

A fifth order polynomial is used to fit the respective polyethylene-equivalent calibration points. A small adjustment to A (from approximately 0.375 to 0.445) is made to correct for column resolution and band-broadening effects, such that linear homopolymer polyethylene standard is obtained at 120,000 Mw. The total plate count of the GPC column set is performed with decane (prepared at “0.04 g in 50 milliliters” of TCB, and dissolved for 20 minutes with gentle agitation.) The plate count (Equation 2) and symmetry (Equation 3) are measured on a 200 microliter injection according to the following equations:
Plate Count 5.54*[(RV_{Peak Max})/(Peak Width at ½ height)]² (EQ2), where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - {RV}_{Peak max} )}{{RV}_{Peak max} - Front Peak {RV}_{one tenth height} )} , \qquad ( EQ3 )$$

the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples are prepared in a semi-automatic manner with the PolymerChar “Instrument Control” Software, wherein the samples are weight-targeted at “2 mg/ml,” and the solvent (contains 200 ppm BHT) is added to a pre nitrogen-sparged, septa-capped vial, via the PolymerChar high temperature autosampler. The samples are dissolved for two hours at 160° C. under “low speed” shaking.

The calculations of Mn_{(GPC)}, Mw_{(GPC)}, and Mz_{(GPC)} are based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{{polyethylene}_{i}} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , and \qquad ( EQ 5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . \qquad ( EQ 6 )$$

In order to monitor the deviations over time, a flowrate marker (decane) is introduced into each sample, via a micropump controlled with the PolymerChar GPC-IR system. This flowrate marker (FM) is used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system, based on a flow marker peak, the effective flowrate (with respect to the narrow standards calibration) is calculated as Equation 7: Flowrate(effective)=Flowrate(nominal)*(RV(FM Calibrated)/RV(FM Sample)) (EQ7). Processing of the flow marker peak is done via the PolymerChar GPCOne™ Software. Acceptable flowrate correction is such that the effective flowrate is within +/−0.7% of the nominal flowrate.

### Experimental

Commercial polymers, experimental polymers and additives are listed in Table 1.

TABLE 1
Commercial and Experimental Polymers and Additives

| | Name | Description | Source |
|---|---|---|---|
| Base resin | EO 3 | Bimodal Ethylene/Octene Copolymer, density | The Dow Chemical |
| | | 0.87 g/cm3, MI 4.31 g/10 min (190° C./2.16 kg) | Company (Dow) |
| | | Vinyl/1000 C = 0.37, total unsaturation = 0.59 | |
| Base resin | EO 10 | Bimodal Ethylene/Octene Copolymer, density | Dow |
| | | 0.87 g/cm3, MI 1.0 g/10 min (190° C./2.16 kg) | |
| | | Vinyl/1000 C = 0.32, total unsaturation = 0.53 | |
| Base resin | ENGAGE 8100 | Density 0.87 g/cm3, MI 1 g/10 min (at 190° C./2.16 kg) | Dow |
| Base resin | ENGAGE 8200 | Density 0.87 g/cm3, MI 5 g/10 min (at 190° C./2.16 kg) | Dow |
| Base resin | EO Mono 5 | Monounsaturated Ethylene/Octene Copolymer | Dow |
| | | (unimodal), density 0.868 g/cm3, | |
| | | I2 = 1.1 g/10 min (190° C./2.16 kg) | |
| | | Vinyl/1000 C = 0.08, total unsaturation = 0.29 | |
| Base resin | EO Mono 3 | Monounsaturated Ethylene/Octene Copolymer | Dow |
| | | (unimodal), density 0.871 g/cm3, | |
| | | I2 = 33.4 g/10 min (190° C./2.16 kg) | |
| | | Vinyl/1000 C = 0.37, total unsaturation = 0.60 | |
| Peroxide | LUPEROX 101 | 2,5-Bis(tert-butylperoxy)-2,5-dimethylhexane | Sigma-Aldrich |
| | | MW = 290.4 g/mole | |
| Coagent | TAIC | Triallyl isocyanurate | Fangruida |
| | | | Chemicals Co., Ltd |
| Tempo | | Bis-(2,2,6,6-tetramethyl-1-piperidinyloxy-4-yl) sebacate | Suqian Unitechem |
| Compound | | MW = 510.7 g/mole | Group |
| Filler | Carbon Black | N550, SPSO | Cabot |

The ¹H NMR, GPC and Rheology characterization results of the commercial and experimental polymers are listed below in Tables 2A, 2B and 2C, respectively.

TABLE 2A
¹H NMR Results

| | I2 | Total | Vinyl/1000 C | Vinylidene/1000 C | Vinylene/1000 C | Trisub/1000 C |
|---|---|---|---|---|---|---|
| Name | dg/min | Unsats/1000 C | (% Vinyl) | (% Vinylidene) | (% Vinylene) | (% Trisub) |
| ENGAGE | 1 | 0.066 | 0.038 | 0.008 | 0.014 | 0.006 |
| 8100 | | | (57.58%) | (12.12%) | (21.21%) | (9.09%) |
| ENGAGE | 5 | 0.097 | 0.052 | 0.013 | 0.020 | 0.012 |
| 8200 | | | | | | |
| EO 3 | 4.31 | 0.59 | 0.37 | 0.12 | 0.08 | 0.02 |
| EO 10 | 1.0 | 0.53 | 0.32 | 0.12 | 0.06 | 0.03 |
| EO Mono 3* | 33.4 | 0.596 | 0.371 | 0.158 | 0.062 | 0.005 |
| | | | (62.25%) | (26.51%) | (10.40%) | (0.84%) |
| EO Mono 5* | 1.1 | 0.294 | 0.080 | 0.061 | 0.145 | 0.008 |
| | | | (27.21%) | (20.75%) | (49.32%) | (2.72%) |

Note,
the % of a particular unsaturation (% pu) = [(amt. pu/1000 C)/(amt. total unsat./1000 C)] × 100; where the % pu = % vinyl, % vinylidene, % vinylene, or % trisub.
*EO = Ethylene/octene copolymer.
*CTA = TEA (Triethylaluminum).

TABLE 2B
GPC Results

| | Mn | Mw | MWD |
|---|---|---|---|
| | (kg/mol) | (kg/mol) | (Mw/Mn) |
| ENGAGE 8100 | 50 | 110 | 2.20 |
| ENGAGE 8200 | 33 | 72 | 2.18 |
| EO 3 | 28.4 | 86.0 | 3.03 |
| EO 10 | 33.3 | 115.5 | 3.46 |
| EO Mono 3 | 21.3 | 49.3 | 2.31 |
| EO Mono 5 | 53.7 | 115.0 | 2.14 |

TABLE 2C
Rheological Properties of First Composition (Polymer or Blend)

| | 85/15 | | | | | 50/50 |
|---|---|---|---|---|---|---|
| | (Mono 5/Mono 3) | | | | | (EO 3/EO 10) |
| | Physical Blend | EG8200 | EG8100 | EO 3 | EO 10 | Physical Blend |
| 12, dg/min (190° C.) | 19.7 | 5 | 1 | 4.31 | 1.0 | 1.74 |
| V0.1, Pa · s (190° C.) | 513 | 1511 | 7936 | 3716 | 17048 | 8561 |
| V100, Pa · s (190° C.) | 276 | 683 | 1546 | 458 | 774 | 624 |
| Ratio of V0.1/V100 | 1.8 | 2.2 | 5.1 | 8.1 | 22.0 | 13.7 |
| Melt strength (cN) | | 0.8 | 3.9 | 1.8 | 6.5 | 3.5 |

Note,
the Density Equation for a blend (for example, the 85/15 blend) is as follows, where wₐ and w_{b} are the respective weight fractions of the blend components, and pₐ and p_{b} are the respective densities of the blend components:
$\frac{1}{ρ} = \frac{{w}_{a}}{{ρ}_{a}} + \frac{{w}_{b}}{{ρ}_{b}} .$ Note,
the equation to determine “total unsaturation/1000 C.” for a blend (for example, the 85/15 blend) is as follows, where wₐ and w_{b} are the respective weight fractions of the blend components, and Unsatₐ and Unsat_{b} are the respective “total unsaturation/1000C” of the blend components:
Unsat = wₐUnsatₐ + w_{b}Unsat_{b}

### Polymer Syntheses for EO 3 and EO 10

EO 3 and EO 10 were each prepared in a one gallon polymerization reactor that was hydraulically full, and operated at steady state conditions. The catalysts and cocatalysts are listed in Table 3A. The solvent, hydrogen, catalysts, and cocatalysts were fed to the reactor according to the process conditions outlined in Tables 3-3D. The solvent was ISOPAR F, supplied by the ExxonMobil Chemical Company. The reactor temperature was measured at or near the exit of the reactor. The copolymer was isolated and pelletized.

TABLE 3A
Catalysts and Cocatalysts

| Catalyst (CAT) | Description |
|---|---|
| BPP-A | 6′,6″′-(propane-1,3-diylbis(oxy))bis(3-(3,6-di-tert-butyl-9H-carbazol-9-yl)-3′-fluoro-5-(2,4,4- |
| WO2012/027448 | trimethylpentan-2-yl)-[1,1′-biphenyl]-2-ol)dimethyl-zirconium |
| BPP-B | 6′,6″′-(((diisopropylsilanediyl)bis(methylene))bis(oxy))bis(3-(3,6-di-tert-butyl-9H-carbazol-9- |
| WO2018/022975 | yl)-3′-fluoro-5-(2,4,4-trimethylpentan-2-yl)-[1,1′-biphenyl]-2-ol)dimethyl-hafnium |
| Cocatalyst | |
| CoCAT 1 | A mixture of methyldi(C₁₄₋₁₈ alkyl)ammonium salts of tetrakis(pentafluorophenyl)borate, |
| | prepared by reaction of a long chain trialkylamine (Armeen ™ M2HT, available from Akzo- |
| | Nobel, Inc.), HCl and Li[B(C₆F₅)₄], substantially as disclosed in U.S. Pat. No. 5,919,983, Ex. 2 (no |
| | further purification performed) (Boulder Scientific) |
| CoCAT 2 | Modified methylalumoxane (MMAO) Type 3A (no further purification performed) (Akzo |
| | Nobel) |

TABLE 3B
Reactor Conditions

| | Reactor | Reactor | | | | | | ethylene |
|---|---|---|---|---|---|---|---|---|
| | Temp., | Pressure | Comonomer | Solvent, | Ethylene, | Comonomer, | Hydrogen, | conversion, |
| | ° C. | psig | Type | lb/hr | lb/hr | lb/hr | sccm | % |
| EO 3 | 197 | 725 | 1-octene | 41.84 | 3.67 | 7.79 | 3.2 | 76.2 |
| EO 10 | 197 | 725 | 1-octene | 41.83 | 3.67 | 7.79 | 3.2 | 75.5 |

TABLE 3C
Catalyst Feed Flows and Efficiency

| | | | CAT-1 | | | CAT-2 | Overall Catalyst |
|---|---|---|---|---|---|---|---|
| | | CAT-1 | Solution | | CAT-2 | Solution | Efficiency, |
| | | Solution | Metal | | Solution | Metal | (g copolymer/g |
| | | Flow, | Conc., | | Flow, | Conc., | total catalyst |
| | CAT-1 | lb/hr | ppm* | CAT-2 | lb/hr | ppm* | metal) |
| EO 3 | BPP-A | 0.47 | 2.15 | BPP-B | 0.70 | 0.98 | 2,820,000 |
| EO 10 | BPP-A | 0.34 | 2.15 | BPP-B | 0.49 | 1.59 | |

*The “ppm” amount based on the weight of the respective catalyst feed solution.

TABLE 3D
Cocatalyst Feed Flows

| | CoCAT 1 Solution | CoCAT 1 Solution | CoCAT 2 Solution | CoCAT 2 Solution |
|---|---|---|---|---|
| | Flow, lb/hr | Conc., ppm* | Flow, lb/hr | Conc., ppm Al** |
| EO 3 | 0.69 | 30.8 | 0.29 | 34.7 |
| EO 10 | 0.58 | 30.8 | 0.24 | 34.7 |

*The “ppm” amount based on the weight of the co-catalyst feed solution.
**The “ppm” amount of Al based on the weight of the co-catalyst feed solution.

### Polymer Synthesis—EO Mono 3 and EO Mono 5

### Catalysts

CAT 2 may by prepared according to the teachings of WO 2011/102989 A1, and has the following structure:

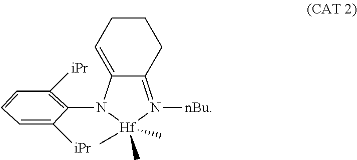

### Polymerization of EO Mono 3 and EO Mono 5

Continuous solution polymerizations of EO Mono 3 (A¹L¹) and EO Mono 5 (A¹L¹) were each carried out in a computer controlled autoclave reactor, equipped with an internal stirrer. Purified mixed alkanes solvent (ISOPAR E available from ExxonMobil), monomers, and molecular weight regulator (hydrogen or chain transfer agent) were supplied to a 3.8 L reactor, equipped with a jacket for temperature control. The solvent feed to the reactor was measured by a mass-flow controller. A variable speed diaphragm pump controlled the solvent flow rate and pressure to the reactor. At the discharge of the pump, a side stream was taken to provide flush flows for the procatalyst, activator, and chain transfer agent (CTA) (catalyst component solutions) injection lines. These flows were measured by mass flow meters, and controlled by control valves. The remaining solvent was combined with monomers and hydrogen, and fed to the reactor. The temperature of the solvent/monomer solution was controlled by use of a heat exchanger, before entering the reactor. This stream entered the bottom of the reactor. The catalyst component solutions were metered using pumps and mass flow meters, and were combined with the catalyst flush solvent, and introduced into the bottom of the reactor. The reactor was liquid full at “500 psig” with vigorous stirring. Polymer was removed through exit lines at the top of the reactor. All exit lines from the reactor were steam traced and insulated. The product stream was then heated at 230° C., by passing through a post reactor heater (PRH), where beta-H elimination of polymeryl-Al took place. A small amount of isopropyl alcohol was added, along with any stabilizers or other additives, after the PRH, and before devolatilization. The polymer product was recovered by extrusion, using a devolatilizing extruder. The polymerization process conditions and results prior to the post reactor heating (PRH) are listed in Tables 4A and 4B.

Abbreviations in the tables are explained as follows: “Co.” stands for comonomer; “sccm” stands for standard cm³/min; “T” refers to temperature; “Cat” stands for Procatalyst; “CAT 2” stands for Procatalyst (CAT 2) as shown above; “CoCAT-1” refers to the cocatalyst defined in Table 4B (footnote); “CTA” stands for chain transfer agent”; “Poly Rate” stands for polymer production rate; “Conv” stands for percent ethylene conversion in reactor; “Eff.” stands for efficiency, kg polymer/mg catalyst metal; “TEA” stands for triethylaluminum, and “C2” stands for ethylene.

TABLE 4A
Polymerization Conditions

| | | | | | | | | CAT | |
|---|---|---|---|---|---|---|---|---|---|
| | | | | | | | | Conc. | CAT |
| | C2 | Co. | Co. | Solv. | H2 | T | | ppm | flow |
| | lbs/hr | Type | lbs/hr | lbs/hr | sccm | ° C. | Cat. | metal* | lbs/hr |
| EO Mono 3 | 2.85 | 1-octene | 5.6 | 36.2 | 0 | 125 | CAT 2 | 124.8 | 0.097 |
| EO Mono 5 | 2.90 | 1-octene | 6.2 | 36.0 | 0 | 140 | CAT 2 | 63.0 | 0.264 |

*The “ppm” amount based on the weight of the respective feed solution.

TABLE 4B

| | CTA* | CTA | | CoCAT | CoCAT | Poly. | | | |
|---|---|---|---|---|---|---|---|---|---|
| | conc. | Flow | | Conc. | Flow | Rate | Conv. | Solids | |
| | ppm*** | lbs/hr | CoCAT** | ppm*** | lbs/hr | lbs/hr | % | % | Eff. |
| EO Mono 3 | 9820 | 0.580 | CoCAT-1 | 120 | 0.082 | 3.95 | 85 | 10.1 | 0.325 |
| EO Mono 5 | 4459 | 0.149 | CoCAT-1 | 1230 | 0.109 | 4.10 | 85 | 10.5 | 0.247 |

*CTA for EO Mono 3 and EO Mono 5 was TEA.
**CoCAT 1 is a mixture of methyldi(C₁₄₋₁₈ alkyl)ammonium salts of tetrakis(pentafluorophenyl)borate, prepared by reaction of a long chain trialkylamine (ARMEEN M2HT, available from Akzo-Nobel, Inc.), HCl and Li[B(C₆F₅)₄], substantially as disclosed in USP 5,919,983, Ex. 2 (no further purification performed) (Boulder Scientific).
***The “ppm” amount based on the weight of the respective feed solution.

### Compositions

Inventive and comparative composition are shown in Table 5 below, along with the rheological properties of the first composition.

TABLE 5
Inventive and Comparative Compositions (amounts in phr based on 100 parts polymer(s))

| phr | CS1 | CS2 | CS3 | IE1 | IE2 | IE3 | CS4 | IE4 | IE5 |
|---|---|---|---|---|---|---|---|---|---|
| EO Mono 3 | 85 | | | | | | 85 | | |
| EO Mono 5 | 15 | | | | | | 15 | | |
| ENGAGE 8200 | | 100 | | | | | | | |
| ENGAGE 8100 | | | 100 | | | | | | |
| EO 3 | | | | 100 | | 50 | | 100 | |
| EO 10 | | | | | 100 | 50 | | | 100 |
| LUPEROX 101 | 1.5 | 1.5 | 1.5 | 1.5 | 1.5 | 1.5 | 0.90 | 0.90 | 0.90 |
| TAIC | | | | | | | 0.45 | 0.45 | 0.45 |
| Tempo Compound | | | | | | | 0.54 | 0.54 | 0.54 |
| Carbon Black | | | | | | | 2.6 | 2.6 | 2.6 |
| V100(190° C.)* | 276 | 683 | 1546 | 458 | 774 | 624 | | | |
| V0.1/V100* | 1.8 | 2.2 | 5.1 | 8.1 | 22.0 | 13.7 | | | |
| I2* (dg/min) | 19.7 | 5 | 1 | 4.3 | 1 | 1.74 | | | |
| Melt Strength*(cN) | | 0.8 | 3.9 | 1.8 | 6.5 | 3.5 | | | |

*Measured on first composition.
Note,
EO Mono 3/EO Mono 5 = 85/15 (wt/wt) blend has a melt index I2 (MI) = 19.7 g/10 min

### Preparation of Compositions IE1-IE3 and CS1-CS3 (No Tempo Compound)

### Soaking

For each composition, the polymer or polymer blend (300 grams pellets) was first soaked with curative (peroxide) in a 1000 mL fluorinated HDPE bottle (from Shanghai Heqi Glassware Co., Ltd.) on a roller (Model NO: 88881004, DESC: Bottle/Tube Roller from Thermo Scientific) at 40° C. for 24 hours (bottle with pellets and curative was rotated at 360 degrees along the horizontal axis of the bottle, 70 rpm). The soaked pellets were used for the following a single screw extrusion with Garvey Die, and a capillary extrusion test.

Single Screw Extrusion with Garvey Die at End of Extruder: IE1-IE3 and CS1-CS3 and Capillary Extrusion Test: IE1-IE3 and CS1-CS3

The extrudability of each composition was evaluated, using a Brabender single screw extruder, equipped with an ASTM Extrusion Garvey Die, and the appearance of the extrudate and its contours were examined. The extrusion was run under the following conditions: Barrel temperature of 110° C. (temp. of three barrels: 110° C., and temp. of Garvey Die: 110° C.), speed of 50 rpm. The soaked pellets (about 250 grams) were added to the extruder, and extruded in the form of a continuous profile (Garvey profile). The extrudate (pre-crosslinked, gel content<5 wt %) was cut into about a “10 cm length” of profile, and placed into hot air oven to form a cross-linked profile. The shape retention of the profile (cross-section, cut by a knife) after thermal treatment in the oven was evaluated. See Table 6.

TABLE 6
Shape Retention after Thermal Treatment
(Garvey Die Extruded Shape)

| Thermal Treatment | CS1 | CS2 | CS3 | IE1 | IE2 | IE3 |
|---|---|---|---|---|---|---|
| 150° C./5 min | Fair | Fair | — | Good | — | — |
| 180° C./5 min | — | Fair | Good | | Good | Good |

Each composition was extruded under the following conditions. Instrument: Gottfert Rheograph 25; Length/diameter=30/2; Barrel Temp. 130° C. The shear rate was increased from 100/s to 500/s. The soaked pellets (around 20 grams) were extruded into a continuous strand (approx. 2-3 mm in diameter). At each shear rate 100/s, 200/s, 300/s, 400/s and 500/s, a short strand was cut for surface quality examination. Capillary extrusion was run at a relatively high shear rate 300/s and 500/s (close to practical extrusion production) to test the surface quality of the various compositions. Results (pre-crosslinked) for shear rate at 300/s and 500/s are shown in Table 7.

TABLE 7
Surface Quality of Extrudate (Capillary Extrusion at 130° C.)

| | CS1 | CS2 | CS2 | CS3 | CS3 | IE1 | IE2 | IE2 | IE3 |
|---|---|---|---|---|---|---|---|---|---|
| Shear Rate (s⁻¹) | 500 | 300 | 500 | 300 | 500 | 500 | 300 | 500 | 500 |
| Surface Quality | Smooth | Slightly | Slightly | Rough | Rough | Smooth | Smooth | Smooth | Smooth |
| | | Rough | Rough | | | | | | |

Slightly Rough = Fine regular corrugation pattern (peaks and valleys).
Rough = Gross irregular corrugation pattern (peaks and valleys).

As seen in Table 7, the comparative compositions CS2 and CS3 (containing ENGAGE 8200 and ENGAGE 8100, respectively) could not obtain a smooth surface (even at 300/s) at 130° C. (which is close to the upper temperature for the extrusion of a composition with a typical peroxide). Comparative composition CS1 had a smooth surface at 500/s. However, comparative compositions CS1 and CS2 could not maintain the Garvey die shape even at a relatively low CV temperature of 150° C., as seen in Table 6. At this temperature (150° C.), the sharp corner of the profile became round. Comparative composition CS3 maintained the profile shape well, even at 180° C. (see Table 6), but the surface quality of the extruded stands was very poor (see Table 7). These results indicated that the comparative compositions cannot achieve good surface quality and shape retention during the extrusion and the vulcanization process.

The inventive compositions (IE1, IE2 and IE3) each achieved a smooth surface at the high shear rate of 500/s (see Table 7). The Garvey die extruded profiles of inventive compositions (IE1-IE3) each maintain its shape much better than the comparative compositions in the vulcanization temperatures of 150° C. and 180° C. (see Table 6).

### Preparation of Compositions IE4, IE5, CS4 and IE6′-IE9′ (With Tempo Compound)

### Soaking and Blending

For each composition, each polymer or polymer blend (300 grams pellets) was first soaked with curatives (peroxide+coagent) in a 1000 mL fluorinated HDPE bottle (see above) on a roller (see above) at 40° C. for 24 hours.

The soaked pellets (1000 grams) were loaded into an internal mixer with a cavity of 1.5 L, at a set temperature of 95° C., and with a rotor speed of 40 rpm. The pellets were homogeneously heated and melted for around two minutes. Afterwards, the Tempo compound (5.4 grams) and carbon black (26 grams) were weighed, and gradually added into the mixing chamber. The mixing was then continued for another six minutes. The mixed composition (pre-crosslinked composition—gum in form) was rolled into sheets (approx. 4 mm thick) on a two-roll mill at 85° C. The sheet was cut into strips (approx. 1.5 cm in width) for MDR analysis (see Table 8) and a Garvey Die extrusion followed by a continuous vulcanization.

Profile Extrusion and then CV (Continuous Vulcanization)—IE4, IE5 and CS4

Each composition was extruded and then vulcanized, in a continuous manner, using a Krauss Maffie Labstar line, which consists of an extruder, a hot air tunnel for vulcanization and a cooling channel. The Garvey die was added to the outlet of the extruder. The extrusion conditions were as follows: barrel temperature 95° C. (one barrel, and temp. of Garvey Die: 95° C.), screw speed 15 rpm. The CV tunnel conditions were as follows: hot air tunnel temperature 200° C., speed 0.6 m/min, tunnel length 4.5 meter. About 800 grams, cut strips, “pre-crosslinked” composition (cut strips—approx. 4 mm thick)” were added to extruder, and extruded in the form of a continuous Garvey profile shape (pre-crosslinked, gel content<5 wt %). The Garvey profile was vulcanized in the hot air tunnel by thermal treatment. The cooled profile was cut (about 1 cm in length) to expose the cross-section for observation. Results are shown in Table 8.

TABLE 8
MDR and Shape Retention Results

| | CS4 | IE4 | IE5*** |
|---|---|---|---|
| Shape retention of Garvey die extrudate after 200° C. | Poor | Good | Good |
| MH (dNm) | 5.42 | 6.57 | 6.85 |
| ML (dNm) | 0.02 | 0.11 | 0.25 |
| (MH − ML) (dNm) | 5.40 | 6.46 | 6.60 |
| T90 | 5.69 | 4.52 | 5.34 |
| V0.1/V100 (resin)* | 1.8 | 8.1 | 22.0 |
| Mole amount of NO•** | 0.00211 | 0.00211 | 0.00211 |
| Mole amount of (O—O) from LUPEROX 101** | 0.006198 | 0.006198 | 0.006198 |
| Molar ratio [NO•/(O—O)] | 0.34 | 0.34 | 0.34 |

*Measured on first composition.
**Moles of NO• from the Tempo Compound = {[Bis-Tempo Compound weight/(MW = 510.7)] * 2};
*Moles of peroxide bonds from LUPEROX 101 = {[LUPEROX 101 weight/(MW = 290.4)] * 2}.
***Surface of IE5 not tacky after vulcanization (Finger Test) - see Table 9 (footnote).

Additional Study—Molar Ratios of [NO⁻/(O—O)]-IE6′ IE9′

Additional comparative compositions (IE6′-IE9′) were prepared and cured as discussed above, and are listed in Table 9. These compositions were compared to IE5 (Table 8). As seen in this table, IE6′, IE8′ and IE9′ had lower MH, lower “MH-ML” and higher T90 values (i.e., decreased curing performance) relative to IE5. IE7′ maintained the curing performance, but the surface after curing was tacky (however, the cured surface of IE5 was not tacky). For IE6′ and IE8′, some blooming was found on their surfaces, which might be caused by the lower curing level and/or the relatively higher loading of the Tempo compound. Such blooming contributed to some extent to the tacky surface of each example.

TABLE 9
MDR, Shape Retention and Surface Quality Results

| phr (based on 100 parts polymer(s)) | IE6′ | IE7′ | IE8′ | IE9′ |
|---|---|---|---|---|
| EO10 | 100 | 100 | 100 | 100 |
| LUPEROX 101 | 0.45 | 0.9 | 0.78 | 0.2 |
| TAIC | 0.45 | 0.45 | 0.45 | 0.45 |
| Tempo Compound (phr) | 0.85 | 0.22 | 1.15 | 0.15 |
| Carbon black | 2.6 | 2.6 | 2.6 | 2.6 |
| Shape retention of Garvey die | good | good | good | good |
| extrudate after curing at 200° C. | | | | |
| MH | 0.94 | 6.97 | 3.85 | 3.36 |
| ML | 0.25 | 0.28 | 0.26 | 0.27 |
| MH − ML | 0.69 | 6.69 | 3.59 | 3.09 |
| T90 | 9.90 | 3.72 | 10.05 | 8.43 |
| V0.1/V100 (resin)* | 22.0 | 22.0 | 22.0 | 22.0 |
| Mole amount of NO• | 0.003329 | 0.000862 | 0.004504 | 0.000587 |
| Mole amount of (O—O) from | 0.003099 | 0.006198 | 0.005372 | 0.001377 |
| LUPEROX 101 | | | | |
| Molar ratio [NO•/(O—O)] | 1.07 | 0.14 | 0.84 | 0.43 |
| Surface quality by Finger Test** | Slightly-tacky | Tacky | Slightly-tacky | Slightly tacky |

*Measured on first composition.
**Finger Test: the hot air crosslinked compositions were tested for surface tackiness using a Finger Test.
The Finger Test is a laboratory qualitative test method. Laboratory personnel use their fingers to touch the top surface of the crosslinked sample, and provide feedback regarding the surface tackiness of the sample.

### SUMMARY

It has been discovered that the inventive compositions formed, in part, from first compositions having unique rheology features (i.e., low viscosity at high shear rate, very high viscosity at low shear rate, and high melt strength), achieve good surface quality and shape retention. Surface quality and shape retention are critical to profile production via extrusion and continuous vulcanization (CV). Low viscosity is usually required for surface smoothness of extruded sample. High viscosity, at low shear rate, and high melt strength are responsible for shape retention during the CV. The DMS values using a broad shear rate range, and the melt strength are shown in Table 5.

1. A composition comprising the following components a) and b):
a) a first composition comprising a multimodal ethylene/alpha-olefin interpolymer, and wherein the first composition comprises the following properties:
$$i ) a density from 0.855 to 0.9 g / cc ,$$
$$ii ) a [ V 100 ( 190 ° C . ) ] \leq 1000 Pa \cdot s ,$$
$$iii ) a [ V 0.1 ( 190 ° C . ) / V 100 ( 190 ° C . ) ] \geq 8. ,$$
b) at least one peroxide.

2. The composition of claim 1, wherein the first composition has a V0.1≥3,000 Pa·s.

3. A composition comprising the following components a) through c):
a) an first composition comprising a multimodal ethylene/alpha-olefin interpolymer, and wherein the first composition comprises the following properties:
$$i ) a density from 0.855 to 0.9 g / cc ,$$
$$ii ) a [ V 0.1 ( 190 ° C . ) / V 100 ( 190 ° C . ) ] \geq 5. ,$$
b) at least one peroxide,
c) at least one Tempo compound of Structure I) selected from Structure IA, Structure IB or Structure IC, each as follows:
Structure IA is 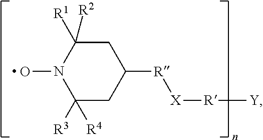
wherein n is an integer≥1;
R1, R2, R3 and R4 are each independently selected from H or a C1-C18 alkyl;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—N(R)—), urethane (—O—C(O)—NH— or —NH—C(O)—O—), carbamide (—NH—C(O)—NH—), or imide (—C(O)—N(R)—C(O)—);
R′ is selected from a C1-C30 alkylene;
R″ may or may not be present, and if present, R″ is selected from a C1-C30 alkylene;
Y is selected from CR₄₋ₙ where n=1 to 4, OR₂₋ₙ where n=1 to 2, NR₃₋ₙ where n=1 to 3, SR₂₋ₙ where n=1 to 2, PR₃₋ₙ where n=1 to 3, PR₅₋ₙ where n=1 to 5, SiR₄₋ₙ where n=1 to 4, a bifunctional C—C core, a phenyl core, a phenyl core substituted with ester, a phenyl core substituted with amide, a tris-isocyanurate core, or a melamine core; and
wherein the bifunctional C—C core is selected from the following structures, where each R′ represents the divalent R′ group in Structure IA above: 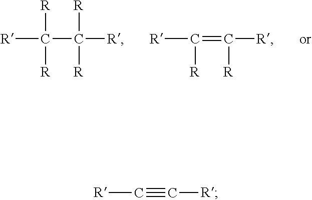
wherein the phenyl core is selected from the following structures, where each R′ represents the divalent R′ group in Structure IA above: 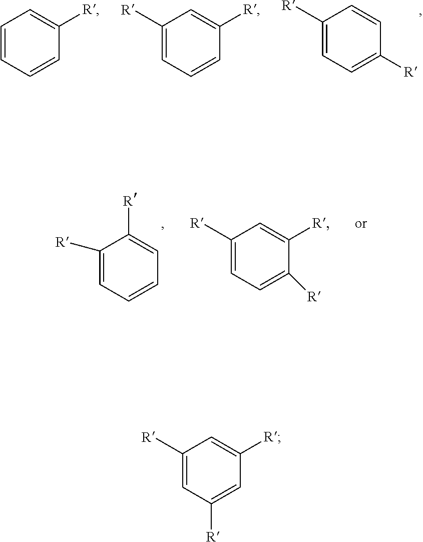
the phenyl core substituted with ester is selected from the following structures, where each R′ represents the divalent R′ group in Structure IA above: 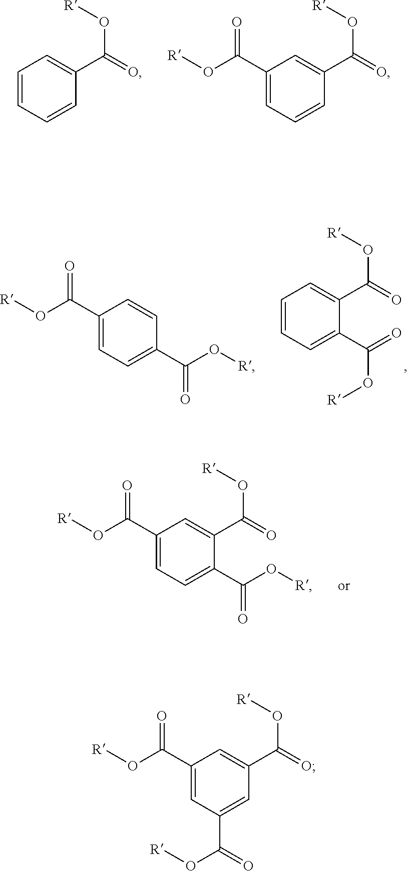
the phenyl core substituted with amide is selected from the following structures, where each R′ represents the divalent R′ group in Structure IA above: 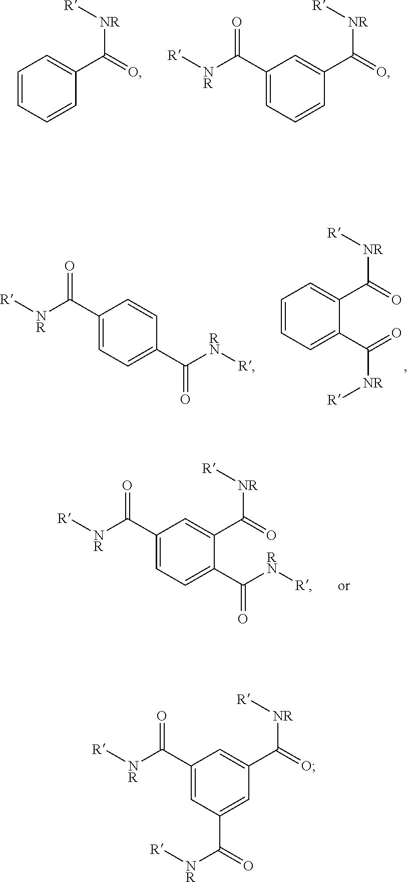
the tris-isocyanurate core is as follows, where each R′ represents the divalent R′ group in Structure IA above; 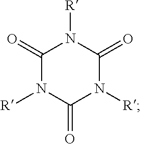
the melamine core is as follows, where each R′ represents the divalent R′ group in Structure IA above; 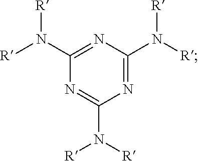
and
wherein each R group in Structure IA is independently selected from H, an unsubstituted hydrocarbyl, a substituted hydrocarbyl, an unsubstituted heterohydrocarbyl or a substituted heterohydrocarbyl;
Structure IB comprises sub-structure IB) as follows: 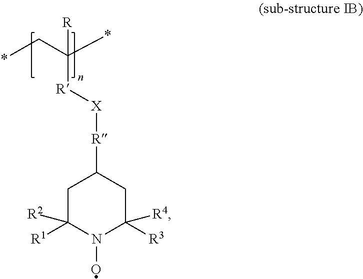
wherein n is an integer≥1;
R1, R2, R3 and R4 are each independently selected from H or a C1-C18 alkyl;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—N(R)—), urethane (—O—C(O)—NH— or —NH—C(O)—O—), carbamide (—NH—C(O)—NH—), or imide (—C(O)—N(R)—C(O)—;
R′ is selected from a C1-C30 alkylene;
R″ may or may not be present, and if present, R″ is selected from a C1-C30 alkylene;
each R group in sub-structure IB is independently selected from H, an unsubstituted hydrocarbyl, a substituted hydrocarbyl, an unsubstituted heterohydrocarbyl or a substituted heterohydrocarbyl;
each * (asterisk) in sub-structure IB represents the respective chemical end of Structure IB;
Structure IC comprises sub-structure IC) as follows: 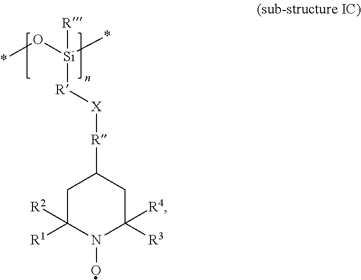
wherein n is an integer≥1;
R1, R2, R3 and R4 are each independently selected from H or a C1-C18;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—NO—), urethane (—O—C(O)—NH— or —NH—C(O)—O—), carbamide (—NH—C(O)—NH—), or imide (—C(O)—N(R)—C(O)—;
R′ is selected from a C1-C30 alkylene;
R″ may or may not be present, and if present, R″ is selected from a C1-C30 alkylene;
each R″′ group in sub-structure IC is independently selected from an unsubstituted hydrocarbyl, a substituted hydrocarbyl, an unsubstituted heterohydrocarbyl or a substituted heterohydrocarbyl;
each R group in sub-structure IC is independently selected from H, an unsubstituted hydrocarbyl, a substituted hydrocarbyl, an unsubstituted heterohydrocarbyl or a substituted heterohydrocarbyl;
each * (asterisk) in sub-structure IC represents the respective chemical end of Structure IC, and if n≥3, then each end may or may not form a cyclic structure with the other end.

4. The composition of claim 3, wherein the first composition has a melt index≤5.0 g/10 min.

5. The composition of claim 3, wherein the molar ratio of the NO⁻ from the at least one Tempo compound (component c) to the peroxide (O—O) bonds from the at least one peroxide (component b) is from 0.30 to 0.90.

6. The composition of claim 3, wherein component c is present in an amount from 0.20 to 0.90 phr, based on 100 parts of component a.

7. The composition of claim 1, wherein the multimodal ethylene/alpha-olefin interpolymer is selected from a multimodal ethylene/alpha-olefin copolymer.

8. The composition of claim 1, wherein the first composition has a total unsaturation≥0.20/1000C.

9. The composition of claim 1, wherein component a further comprises second multimodal ethylene/alpha-olefin interpolymer with a density from 0.855 to 0.900 g/cc, and a total unsaturation≥0.20/1000C, and this second interpolymer is different from the multimodal ethylene/alpha-olefin interpolymer.

10. The composition of claim 9, wherein the second multimodal ethylene/alpha-olefin interpolymer is a multimodal ethylene/alpha-olefin copolymer.

11. The composition of claim 9, wherein the ratio of the density of the multimodal ethylene/alpha-olefin interpolymer to the density of the second multimodal ethylene/alpha-olefin interpolymer is from 0.80, to 1.25.

12. The composition of claim 1, wherein the composition comprises ≤10 wt % of a filler, based on the weight of the composition.

13. A process to form a crosslinked composition, the process comprising thermally treating a composition comprising the following components a) and b):
a) a first composition comprising a multimodal ethylene/alpha-olefin interpolymer, and wherein the first composition comprises the following properties: i) a density from 0.855 to 0.900 g/cc, ii) a V100 (190° C.)≤1000 Pa·s, iii) a [V0.1 (190° C.)/V100 (190° C.)]≥8.0;
b) at least one peroxide.

14. The process of claim 13, wherein the first composition has a V0.1 (190° C.)≥3,000 Pa·s.

15. A process to form a crosslinked composition, the process comprising thermally treating the composition of claim 3.

16. The process of claim 15, wherein the first composition has a melt index (I2)≤5.0 g/10 min.

17. The process of claim 15, wherein the molar ratio of the NO⁻ from the at least one Tempo compound (component c) to the peroxide (O—O) bonds from the at least one peroxide (component b) is from 0.30 to 0.90.

18. The process of claim 15, wherein component c is present in an amount from 0.20 to 0.90 phr, based on 100 parts of component a.

19. The process of claim 13, wherein the thermal treatment takes place in air.

20. An article comprising at least one component formed from the composition of claim 1.
